(19) United States
(12) Patent Application Publication
(10) Pub. No.: US 2018/0257104 A1
(43) Pub. Date: Sep. 13, 2018

(54) METHOD OF PRODUCING TRANSPARENT RESIN BASE PRINTED MATERIAL

(71) Applicant: FUJIFILM CORPORATION, Tokyo (JP)

(72) Inventors: Yanlong CHE, Shizuoka (JP); Toshiyuki MAKUTA, Shizuoka (JP); Masafumi YOSHIDA, Shizuoka (JP); Ryou HIBINO, Shizuoka (JP)

(21) Appl. No.: 15/978,210

(22) Filed: May 14, 2018

Related U.S. Application Data
(63) Continuation of application No. PCT/JP2016/084674, filed on Nov. 22, 2016.

(30) Foreign Application Priority Data
Dec. 7, 2015 (JP) 2015-238881

(51) Int. Cl. B05D 1/26; B41J 2/135; B41M 5/52; G02B 3/06; C09D 11/30; C09D 11/54

(52) U.S. Cl. CPC B05D 1/265; B41J 2/135; B41M 5/52; B05D 2252/10; C09D 11/30; C09D 11/54; G02B 3/06

(57) ABSTRACT

Provided is a method of producing a transparent resin base printed material, including: a treatment liquid applying step of applying a treatment liquid which contains an acidic compound onto a transparent resin base material; an ink jetting step of jetting an aqueous ink, which contains a colorant, resin particles, water, and a solvent having a boiling point of 150° C. to 250° C. and in which the content of a solvent having a boiling point of higher than 250° C. is 1% by mass or less with respect to the total mass of the ink, onto the transparent resin base material to which the treatment liquid has been applied according to an ink jet system; and a drying step of drying the aqueous ink under a condition in which the surface temperature of the transparent resin base material is in a range of 60° C. to 100° C.

### CROSS-REFERENCE TO RELATED APPLICATIONS

This application is a continuation application of International Application No. PCT/JP2016/084674, filed Nov. 22, 2016, the disclosure of which is incorporated herein by reference in its entirety. Further, this application claims priority from Japanese Patent Application No. 2015-238881, filed Dec. 7, 2015, the disclosure of which is incorporated herein by reference in its entirety.

### BACKGROUND OF THE INVENTION

### 1. Field of the Invention

The present invention relates to a method of producing a transparent resin base printed material.

### 2. Description of the Related Art

In recent years, a method of producing a printed material using an ink jet system has been widely used since an image can be formed at a high speed, a high-quality image can be formed on various kinds of base materials, and this production method can cope with small lot production.

From the viewpoint of considering the global environment and the work environment, an aqueous ink using water as a vehicle has been known, in addition to a solvent ink using a solvent as a vehicle, as an ink used for producing a printed material according to the ink jet system. In recent years, the production of a printed material using an aqueous ink has been attracting attention from the above-described viewpoint.

As an aqueous ink, an aqueous ink composition containing a colorant and composite particles which are obtained by polymerizing a monomer constituting a second polymer in the presence of a polymer aqueous dispersion obtained by using water and a polymer solution that contains at least one of a first polymer or a water-soluble solvent having a specific structure and in which the first polymer has a hydrophilic structural unit and a hydrophobic structural unit, and the glass transition temperature of at least one of the first polymer or the second polymer is 120° C. or higher has been suggested (for example, see JP2011-038008A).

Further, JP2011-038008A describes an image forming method using the above-described aqueous ink composition.

The printed material produced according to a method using the ink jet system is used for applications such as commercial printing applications, sign applications, or lenticular applications.

A lenticular printed material which is obtained by combining a lenticular lens and a parallax picture (lenticular image) and in which the display content is switched depending on a stereoscopic image and a viewing direction is used for the lenticular applications.

The lenticular printed material is produced according to a method of printing a parallax picture on paper and bonding a lenticular lens, formed by semicylindrical lenses being disposed in parallel, to the parallax picture or a method of forming a parallax picture directly on a flat surface on the opposite side of a convex lens of the lenticular lens.

As a lenticular sheet used for producing a lenticular printed material, a printing sheet for a stereoscopic image which includes a transparent support formed by bonding a plurality of resin films to one another; a lens layer formed on one surface of the transparent support; and an image-receiving layer that is formed on the other surface of the transparent support and records an image has been suggested (for example, see JP2012-255879A).

Further, a lens sheet which includes a first surface formed by arranging a plurality of lenses extending in a longitudinal direction in parallel and a second surface which is a surface provided on the opposite side of the first surface, is a surface to be printed, or a surface to which a printed medium is bonded and in which the external form thereof is a rectangle or a square, and respective lenses are arranged to be inclined to the sheet edge has been suggested (for example, see JP2009-104154A).

Further, as an image forming device that forms an image on a lenticular sheet, a stereoscopic image printing device that includes a first transport unit which transports paper in a transport direction as a sheet-like recording medium; an ink jetting unit which includes a plurality of nozzles arranged in a direction substantially orthogonal to the transport direction and jets ink from the plurality of nozzles to the recording medium to be transported to form a parallax picture; a drive control unit which drives and controls the ink jetting unit in synchronization with the transport in accordance with an image to be formed on the recording medium, drives the ink jetting unit by time-dividing the driving cycle of the nozzles such that a parallax picture is formed with ink image points that are finer in the transport direction than those in the arrangement direction of the nozzles; a second transport unit which transports a sheet-like transport medium that controls light beams from the parallax picture such that a light beam control element making a stereoscopic image visible is formed to the first transport unit and allows the transparent medium to be superimposed on the recording medium; an element forming unit which forms the light beam control element on the transparent medium on the first transport unit; and a pressure-bonding unit which pressure-bonds and fixes the transparent medium, to be transported in the transport direction along with the recording medium, to the recording medium has been suggested (for example, see JP2010-237318A).

### SUMMARY OF THE INVENTION

From the viewpoint of preventing an aqueous ink composition from being dried, a solvent having a relatively high boiling point (for example, a solvent having a boiling point of higher than 250° C.) tends to be used, as a vehicle, for an aqueous ink composition of the related art as in the aqueous ink composition described in JP2011-038008A. Therefore, in a case where an aqueous ink composition is applied to a medium to be recorded (for example, a transparent resin base material), a high temperature is selected as a condition for drying the aqueous ink composition in some cases.

In a case where an aqueous ink composition is dried at a high temperature as described above, a medium to be recorded (particularly, a transparent resin base material) is deformed due to heat in some cases. Such deformation of the medium to be recorded due to heat is not problematic in many cases in applications to large advertisement signboards installed outdoors. However, for example, the deformation may cause a problem in applications requiring high dimensional accuracy for a base material such as applications to a printing sheet for a stereoscopic image described in JP2012-255879A and lenticular applications such as applications to a lens sheet or the like described in JP2009-104154.

In addition, the above-described problem does not occur in a case where a lenticular printed material is prepared using a method of forming an image on a recording medium and pressure-bonding a transparent medium to the recording medium as in the stereoscopic image printing device described in JP2010-237318A. Therefore, the problem generated due to the method of directly applying an aqueous ink to the recording medium has not been examined in the invention described in JP2010-237318A.

As a method of suppressing deformation of a medium to be recorded due to heat, a method of drying an aqueous ink composition at a low temperature is exemplified. However, in a case where an aqueous ink composition is dried at a low temperature, the fixing properties of an image may deteriorate since the solvent remains even after the aqueous ink composition has been dried.

As described above, in a case where a printed material is produced according to an ink jet system using an aqueous ink composition in applications requiring high dimensional accuracy for a base material, both of suppression of thermal deformation of a medium to be recorded and the fixing properties of an image have not been achieved.

An object of an embodiment of the present invention is to provide a method of producing a transparent resin base printed material which suppresses thermal deformation and has excellent fixing properties for an image.

Specific means for solving the above-described problems includes the following aspects.

<1> A method of producing a transparent resin base printed material, comprising: a treatment liquid applying step of applying a treatment liquid which contains an acidic compound onto a transparent resin base material; an ink jetting step of jetting an aqueous ink, which contains a colorant, resin particles, water, and a solvent having a boiling point of 150° C. to 250° C. and in which a content of a solvent having a boiling point of higher than 250° C. is 1% by mass or less with respect to the total mass of the ink, onto the transparent resin base material to which the treatment liquid has been applied according to an ink jet system; and a drying step of drying the aqueous ink under a condition in which a surface temperature of the transparent resin base material is in a range of 60° C. to 100° C.

<2> The method of producing a transparent resin base printed material according to <1>, in which the ink jet system is a single pass system.

<3> The method of producing a transparent resin base printed material according to <1> or <2>, in which the aqueous ink is jetted in the ink jetting step under jetting conditions of a resolution of 1200 dots per inch (dpi) or greater and a minimum liquid droplet size of 3 pl or less.

<4> The method of producing a transparent resin base printed material according to any one of <1> to <3>, in which the transparent resin base material is a lenticular sheet which includes a resin layer and a lens layer.

<5> The method of producing a transparent resin base printed material according to <4>, in which the resin layer is a biaxially stretched resin layer.

<6> The method of producing a transparent resin base printed material according to <4> or <5>, in which the lenticular sheet includes a lens layer on one surface of the resin layer and an ink receiving layer on the other surface of the resin layer.

<7> The method of producing a transparent resin base printed material according to any one of <4> to <6>, in which a thermal shrinkage of the resin layer when heated at 150° C. for 30 minutes is in a range of 0.0%±0.6%.

According to an embodiment of the present invention, it is possible to provide a method of producing a transparent resin base printed material which suppresses thermal deformation and has excellent fixing properties for an image.

### BRIEF DESCRIPTION OF THE DRAWINGS

FIG. 1 is a cross-sectional view schematically illustrating an example of a lenticular sheet.

FIG. 2 is a view schematically illustrating an example of the whole structure of an ink jet recording device.

FIG. 3 is a photograph showing the result of evaluating heat resistance of a lenticular sheet prepared in an example.

FIG. 4 is a view schematically illustrating a lenticular printed material prepared in an example by enlarging a portion thereof.

### DESCRIPTION OF THE PREFERRED EMBODIMENTS

Hereinafter, a method of producing a transparent resin base printed material according to the present disclosure will be described in detail.

In the present specification, the numerical ranges expressed using “to” indicate the ranges including the numerical values described before and after “to” as the lower limits and the upper limits.

In the present specification, the term “transparent” means that the light transmittance for light (having a wavelength of 400 nm to 700 nm) at least in a visible region is 70% or greater. Further, the visible light transmittance is a value measured using a spectrophotometer.

<Method of Producing Transparent Resin Base Printed Material>

A method of producing a transparent resin base printed material of the present disclosure includes a treatment liquid applying step of applying a treatment liquid which contains an acidic compound onto a transparent resin base material; an ink jetting step of jetting an aqueous ink, which contains a colorant, resin particles, water, and a solvent having a boiling point of 150° C. to 250° C. and in which the content of a solvent having a boiling point of higher than 250° C. is 1% by mass or less, onto the transparent resin base material to which the treatment liquid has been applied according to an ink jet system; and a drying step of drying the aqueous ink under a condition in which the surface temperature of the transparent resin base material is in a range of 60° C. to 100° C.

The reason why the effects are exerted according to the above-described production method is not clear, but can be assumed as follows.

It has been considered difficult to achieve both of suppression of deformation caused by heat and the fixing properties of an image in applications requiring high dimensional accuracy since a process of heating and drying is indispensable in the production of a printed material using an aqueous ink of the related art.

According to the method of producing a transparent resin base printed material of the present disclosure, an aqueous ink which contains water, resin particles, and a solvent having a boiling point of 150° C. to 250° C. and in which the content of a solvent having a boiling point of higher than 250° C. is 1% by mass or less is applied onto the transparent resin base material, and the aqueous ink is dried under a condition in which the surface temperature of the transparent resin base material is in a range of 60° C. to 100° C.

Since the boiling point of the solvent used in the above-described production method is low, the solvent is unlikely to remain after the aqueous ink is dried even through the drying temperature is in a range of 60° C. to 100° C., and the aqueous ink is easily fixed to the transparent resin base material. Therefore, an image having excellent fixing properties is obtained.

As described above, by combining selecting of a solvent having a boiling point in a specific range as the solvent contained in the aqueous ink and drying of the aqueous ink under a specific temperature condition for formation of an image according to an ink jet method, the impact of heat on the transparent resin base material during drying can be suppressed and the solvent is unlikely to remain in the aqueous ink on the image after drying. Therefore, thermal deformation of the transparent resin base material is considered to be suppressed so that a transparent resin base printed material having excellent fixing properties to an image can be produced.

[Treatment Liquid Applying Step]

The method of producing a transparent resin base printed material according to the present disclosure includes a treatment liquid applying step of applying a treatment liquid that contains an acidic compound onto the transparent resin base material.

According to the method of producing a transparent resin base printed material, a printed material is obtained by applying a treatment liquid and an aqueous ink onto the transparent resin base material and drying the treatment liquid and the aqueous ink. The treatment liquid applying step provided before an aqueous ink jetting step described below is a step of applying a treatment liquid containing at least one acidic compound that aggregates components in the aqueous ink described below onto the transparent resin base material. In this step, the components in the aqueous ink to be applied in the aqueous ink jetting step are aggregated. Since the components in the aqueous ink are aggregated on the transparent resin base material, an image can be formed on the transparent resin base material.

(Transparent Resin Base Material)

The transparent resin base material can be selected from base materials which are transparent and contain a resin having heating resistance in the drying step described below.

Examples of the resin that can form a transparent resin base material include polyester (such as polyethylene terephthalate or polyethylene naphthalate), polycarbonate, polysulfone, wholly aromatic polyamide, an acrylic resin (such as polymethyl methacrylate (PMMA) or polymethyl acrylate), a urethane resin, polystyrene, a methacrylate-styrene copolymer resin (MS resin), an acrylonitrile-styrene copolymer resin (AS resin), an ethylene-vinyl alcohol copolymer, modified polyolefin, polypropylene, polyethylene, polyvinyl chloride (PVC), a thermoplastic elastomer, and a cycloolefin polymer.

A shape of a plate such as a film or a sheet is preferable as the shape of the transparent resin base material. The transparent resin base material may be formed of a single layer or may have a laminated structure formed by two or more layers being laminated on one another. In a case where the transparent resin base material has a laminated structure, respective layers may be formed of the same resin or different resins.

It is preferable that the transparent resin base material includes a resin layer stretched in at least one direction. In a case where the transparent resin base material includes a resin layer stretched in at least one direction, the heat resistance of the transparent resin base material is improved and deformation caused by heating in the drying step described below can be further suppressed.

In a case where the transparent resin base material is formed of a single layer, a uniaxially stretched film can be used. Further, in the case where the transparent resin base material is formed of a single layer, a biaxially stretched film can be also used.

From the above-described viewpoint, it is preferable that the resin layer is a biaxially stretched resin layer.

In a case where the transparent resin base material has a laminated structure, another layer may be laminated on the resin layer after the resin layer is stretched or the resin layer may be stretched after another layer is laminated on the resin layer.

The resin layer may be stretched in a machine direction (MD) or in a transverse direction (TD). In a case where the resin layer is biaxially stretched, both of the stretching in MD and the stretching in TD are performed.

The stretching ratio in the stretching is preferably in a range of 1.5 times to 7 times, more preferably in a range of 1.7 times to 5 times, and still more preferably in a range of 2 times to 4 times. In a case where the stretching ratio is in a range of 1.5 times to 7 times, the mechanical strength of the resin layer is improved so that the uniformity of the thickness is improved. Further, in a case where the transparent resin base material has a laminated structure, the adhesiveness between the resin layer and another layer can be improved.

The resin layer is stretched at a temperature of preferably 170° C. or higher, more preferably 200° C. to 320° C., and still more preferably 200° C. to 300° C. In a case where the temperature of performing the stretching is higher than or equal to the glass transition temperature (Tg) of the resin layer, the heat resistance of the transparent resin base material is improved so that the deformation caused by heating in the drying step described below can be further suppressed.

—Resin Layer—

The resin that forms the resin layer can be selected from the resins contained in the transparent resin base material described above.

A shape of a plate such as a film or a sheet is preferable as the shape of the resin layer.

In the case where the resin layer is stretched, the thickness of the resin layer is determined depending on the stretching ratio. Specifically, the thickness thereof is preferably in a range of 25 μm to 250 μm, more preferably in a range of 50 μm to 250 μm, and still more preferably in a range of 100 μm to 250 μm.

The thermal shrinkage of the resin layer at the time of being heated at 150° C. for 30 minutes is preferably in a range of 0.0%±0.6%, more preferably in a range of 0.0%±0.4%, and still more preferably in a range of 0.0%±0.3%.

In a case where the thermal shrinkage is in a range of 0.0%±0.6%, the deformation of the transparent resin base material caused by heat generated when the aqueous ink is dried can be further suppressed.

The thermal shrinkage can be measured in conformity with “21. Dimensional Change” of JIS C 2151:2006.

—Ink Receiving Layer—

The transparent resin base material may include an ink receiving layer.

In a case where the transparent resin base material includes an ink receiving layer, liquid droplets of the landed aqueous ink can be reduced, and the drying temperature in the drying step described below can be lowered.

It is preferable that the ink receiving layer contains a resin and more preferable that at least a part of the resin is cross-linked by a cross-linking agent.

At least one resin selected from polyester, an acrylic resin, and a urethane resin is preferable as the resin.

Hereinafter, polyester, an acrylic resin, and a urethane resin will be described.

——Polyester——

The main constituent components of polyester are, for example, a polyvalent carboxylic acid and a polyvalent hydroxy compound described below. Examples of the polyvalent carboxylic acid include terephthalic acid, isophthalic acid, orthophthalic acid, phthalic acid, 4,4′-diphenyldicarboxylic acid, 2,5-naphthalenedicarboxylic acid, 1,5-naphthalenedicarboxylic acid, 2,6-naphthalenedicarboxylic acid, 2,7-naphthalenedicarboxylic acid, 1,4-cyclohexanedicarboxylic acid, 2-sodium sulfoterephthalic acid, 2-potassium sulfoterephthalic acid, 4-sodium sulfoisophthalic acid, 4-potassium sulfoisophthalic acid, 5-sodium sulfoisophthalic acid, 5-potassium sulfoisophthalic acid, adipic acid, azelaic acid, sebacic acid, dodecane dicarboxylic acid, glutaric acid, succinic acid, trimellitic acid, trimesic acid, pyromellitic acid, trimellitic anhydride, pyromellitic anhydride, phthalic anhydride, p-hydroxybenzoic acid, trimellitic acid monopotassium salt, and ester-forming derivatives of these.

Examples of the polyvalent hydroxy compound include ethylene glycol, 1,2-propylene glycol, 1,3-propylene glycol, 1,3-propanediol, 1,4-butanediol, 1,6-hexanediol, 2-methyl-1,5-pentanediol, neopentyl glycol, 1,4-cyclohexanedimethanol, p-xylylene glycol, a bisphenol A-ethylene glycol adduct, diethylene glycol, triethylene glycol, polyethylene glycol, polypropylene glycol, polytetramethylene glycol, polytetramethylene oxide glycol, dimethylolpropionic acid, glycerin, trimethylolpropane, sodium dimethylol ethyl sulfonate, potassium dimethylol ethyl sulfonate, and potassium dimethylol propionate.

Polyester may be synthesized by respectively selecting one or more compounds from among these compounds as appropriate using a polycondensation reaction according to a method of the related art.

The number average molecular weight of the polyester is preferably 5000 or greater, more preferably 8000 or greater, and still more preferably 10000 or greater. By setting the number average molecular weight of the polyester to be in the above-described range, the adhesiveness between the ink receiving layer and a layer adjacent to the ink receiving layer is improved.

As the number average molecular weight, a value measured by gel permeation chromatography (GPC) is employed.

The GPC is performed using HLC-8020GPC (manufactured by Tosho Corporation), three columns of TSKgel (registered trademark) and Super Multipore HZ-H (manufactured by Tosho Corporation, 4.6 mmID×15 cm), and tetrahydrofuran (THF) as an eluent.

Further, the GPC is performed at a sample concentration of 0.45% by mass, a flow rate of 0.35 ml/min, a sample injection volume of 10 μl, and a measurement temperature of 40° C. using a differential refractive index (RI) detector.

The calibration curve is prepared using 8 samples of “F-40”, “F-20”, “F-4”, “F-1”, “A-5000”, “A-2500”, “A-1000”, and “n-propylbenzene” which are “Standard Samples TSK standard, polystyrene” (manufactured by TOSOH CORPORATION).

The content of the polyester in the ink receiving layer is preferably in a range of 10% by mass to 80% by mass, more preferably in a range of 15% by mass to 75% by mass, and still more preferably in a range of 30% by mass to 50% by mass with respect to the total mass of the ink receiving layer. By setting the content of the polyester to be in the above-described range, the adhesiveness between the ink receiving layer and a layer adjacent to the ink receiving layer can be improved.

The glass transition temperature (Tg) of the polyester which can be contained in the ink receiving layer is preferably lower than 60° C. Further, in a case where a plurality of polyesters are contained in the ink receiving layer, the glass transition temperature of each polyester is more preferably lower than 60° C. Further, it is preferable that the polyester which can be contained in the ink receiving layer is copolymer polyester having a naphthalene ring. In a case where the resin which can be contained in the ink receiving layer is copolymer polyester, an ink receiving layer having excellent adhesiveness to the resin layer is easily obtained. Further, in a case where the glass transition temperature of the copolymer polyester which can be contained in the ink receiving layer is lower than 60° C., an ink receiving layer having excellent adhesiveness to the aqueous ink used for forming an image on a surface of the ink receiving layer is formed. From the viewpoint of the adhesiveness, the glass transition temperature of the copolymer polyester contained in the ink receiving layer is more preferably 50° C. or lower.

A measured value Tg obtained by actual measurement is applied to the glass transition temperature.

Specifically, the measured value Tg indicates a value measured using a differential scanning calorimeter (DSC) EXSTAR6220 (manufactured by Seiko Instruments Inc.) under typical measurement conditions. In a case where it is difficult to perform measurement due to decomposition or the like of the material, a calculated value Tg to be calculated by the following calculation formula is applied. The calculated value Tg indicates a value calculated by Formula (1).

1/Tg=Σ(Xi/Tgi) (1)

Here, it is assumed that the polymer as a target for calculation is formed by copolymerizing n monomer components (in the formula, i represents 1 to n). Xi represents a weight fraction (ΣXi=1) of the i-th monomer and Tgi represents a glass transition temperature (absolute temperature) of a homopolymer of the i-th monomer. Here, Σ is obtained by summing 1 to n as i. Further, values in Polymer Handbook (3rd Edition) (written by J. Brandrup, E. H. Immergut (Wiley-Interscience, 1989)) are employed as the value (Tgi) of the glass transition temperature of the homopolymer of each monomer.

The copolymer polyester which can be contained in the ink receiving layer may be a mixture of two or more kinds of polyesters. In a case of the mixture, it is preferable that polyesters having a glass transition temperature of lower than 60° C. are mixed because an ink receiving layer having excellent adhesiveness to the aqueous ink used for forming an image on the surface of the ink receiving layer can be obtained. The concentration of the polyesters having a glass transition temperature of lower than 60° C. in the copolymer polyester contained in the ink receiving layer is preferably 90% by mass or greater and more preferably 95% by mass or greater.

By using a compound that has a naphthalene ring as the copolymer polyester which can be contained in the ink receiving layer, deposition of an oligomer on the surface of the ink receiving layer can be prevented. The reason why deposition of the oligomer is prevented is assumed that the compatibility between the oligomer component from the resin layer and the copolymer polyester having a naphthalene ring is high.

Further, the glass transition temperature of the polyester which can be contained in the ink receiving layer is preferably −20° C. or higher. Further, the glass transition temperature of the polyester contained in the ink receiving layer is preferably in a range of −20° C. to 60° C. and more preferably in a range of −10° C. to 50° C.

The glass transition temperature is measured according to a method of the related art.

The copolymer polyester having a naphthalene ring tends to have a higher glass transition temperature than that of the copolymer polyester which does not have a naphthalene ring. Among copolymer polyester having a naphthalene ring, it is preferable that the polyester having a glass transition temperature of lower than 60° C. is copolymer polyester containing a dicarboxylic acid and a diol as copolymer components.

Dicarboxylic Acid

As a structural unit derived from a dicarboxylic acid, a structural unit derived from 2,6-naphthalenedicarboxylic acid is preferable. Further, among the copolymer polyesters having a naphthalene ring, the copolymer polyester having a glass transition temperature of lower than 60° C. may have a structural unit represented by Formula (2) and derived from a dicarboxylic acid, terephthalic acid, or isophthalic acid as the structural unit of a dicarboxylic acid.

HOOC—(CH₂)ₙ—COOH (in the formula, n represents a natural number of 4 to 10). Formula (2)

From the viewpoint of obtaining an ink receiving layer having excellent adhesiveness to a layer adjacent to the ink receiving layer, it is preferable that a ratio X of the structural unit derived from 2,6-naphthalenedicarboxylic acid to all structural units derived from a dicarboxylic acid in the copolymer polyester having a naphthalene ring is in a range of 30% by mass to 90% by mass. The ratio X thereof is more preferably in a range of 40% by mass to 80% by mass and still more preferably in a range of 50% by mass to 75% by mass.

In order to obtain copolymer polyester in which the ratio X is in the above-described range, the ratio of the dicarboxylic acid having a naphthalene ring in the dicarboxylic acid used for preparing the copolymer polyester is preferably in a range of 30% by mass to 90% by mass, similar to the ratio X. Further, the ratio of the dicarboxylic acid having a naphthalene ring in the dicarboxylic acid used for preparing the copolymer polyester is more preferably in a range of 40% by mass to 80% by mass and still more preferably in a range of 50% by mass to 75% by mass.

Diol

As a structural unit derived from a diol in the copolymer polyester (hereinafter, also referred to as a “diol structural unit”), a diol structural unit which makes the glass transition temperature of the copolymer polyester low is preferable. Preferred examples of the diol structural unit include diol structural units derived from a diol such as ethylene glycol, diethylene glycol, or triethylene glycol, in addition to diols represented by formula (3).

HO—(CH₂)ₘ—OH (in the formula, m represents a natural number of 4 to 10). Formula (3)

From the viewpoint of obtaining an ink receiving layer having excellent adhesive strength to the ink that forms an image, it is preferable that a ratio Y of the structural unit derived from the diol represented by Formula (3) to all diol structural units in the copolymer polyester is in a range of 10% by mass to 95% by mass. The ratio Y thereof is more preferably in a range of 20% by mass to 90% by mass and still more preferably in a range of 30% by mass to 85% by mass.

In order to prepare copolymer polyester in which the ratio Y is in the above-described range, the ratio of the diol represented by Formula (3) in the diol used for preparing the copolymer polyester is preferably in a range of 10% by mass to 95% by mass, similar to the ratio Y. Further, the ratio of the diol represented by Formula (3) in the diol used for preparing the copolymer polyester is more preferably in a range of 20% by mass to 90% by mass and still more preferably in a range of 30% by mass to 85% by mass.

As the polyester which can be used in the present invention, commercially available products such as PLASCOAT Z-592 and Z-687 (manufactured by GOO CHEMICAL CO., LTD.) can also be used.

——Acrylic Resin——

An acrylic resin is a polymer formed of a polymerizable monomer having a carbon-carbon double bond, which is represented by an acrylic monomer or a methacrylic monomer. The acrylic resin may be a homopolymer or a copolymer. Further, the acrylic resin includes a copolymer with another polymer (for example, polyester or polyurethane). The copolymer with another polymer may be a block copolymer or a graft copolymer. Alternatively, a polyester solution or a polyester dispersion liquid also contains a polymer (a mixture of polymers in some cases) obtained by polymerizing a polymerizable monomer having a carbon-carbon double bond. Similarly, in a case of polyurethane, a polyurethane solution or a polyurethane dispersion liquid also contains a polymer (a mixture of polymers in some cases) obtained by polymerizing a polymerizable monomer having a carbon-carbon double bond. In the same manner, another polymer solution or another polymer dispersion liquid also contains a polymer (a mixture of polymers in some cases) obtained by polymerizing a polymerizable monomer having a carbon-carbon double bond.

The polymerizable monomer having a carbon-carbon double bond is not particularly limited, and examples thereof include carboxy group-containing polymerizable monomers such as acrylic acid, methacrylic acid, crotonic acid, itaconic acid, fumaric acid, maleic acid, and citraconic acid, and a polymerizable monomer in which a carboxy group forms a salt; various hydroxyl group-containing monomers such as 2-hydroxyethyl (meth)acrylate, 2-hydroxypropyl (meth)acrylate, 4-hydroxybutyl (meth)acrylate, monobutyl hydroxy fumarate, and monobutyl hydroxy itaconate; various (meth)acrylic acid esters such as methyl (meth)acrylate, ethyl (meth)acrylate, propyl (meth)acrylate, butyl (meth)acrylate, and lauryl (meth)acrylate; various nitrogen-containing compounds such as (meth)acrylamide, diacetone acrylamide, N-methyloyl acrylamide, and (meth)acrylonitrile; various styrene derivatives such as styrene, α-methylstyrene, divinylbenzene, and vinyl toluene, and various vinyl esters such as vinyl propionate; various silicon-containing polymerizable monomers such as γ-methacryloxy propyl trimethoxysilane, and vinyl trimethoxysilane; phosphorus-containing vinyl-based monomers; various halogenated vinyls such as vinyl chloride and vinylidene chloride; and various conjugated dienes such as butadiene.

The polymerizable monomer having a carbon-carbon double bond may be used alone or in combination of two or more kinds thereof.

——Urethane Resin——

The urethane resin is a general term of a polymer having a urethane bond in the main chain thereof and is typically obtained by a reaction between a polyisocyanate and a polyol.

Examples of the polyisocyanate include tolylene diisocyanate (TDI), diphenylmethane diisocyanate (MDI), naphthalene diisocyanate (NDI), hexamethylene diisocyanate (HDI), and isophorone diisocyanate (IPDI). Further, as the polyisocyanate, a polymer whose molecular weight is increased by applying a chain extension treatment to the polyurethane polymer obtained by the reaction between a polyisocyanate and a polyol and which contains an isocyanate group in a terminal is also exemplified.

Examples of the polyol include ethylene glycol, propylene glycol, glycerin, and hexanetriol.

The polyisocyanate, the polyol, and the chain extension treatment described above are described in, for example, “Polyurethane Handbook” (edited by Keiji Iwata, NIKKAN KOGYO SHIMBUN, LTD., published in 1987). In addition, the urethane resin contained in the ink receiving layer may be used alone or in combination of two or more kinds thereof.

The glass transition temperature of the urethane resin contained in the ink receiving layer is preferably in a range of −40° C. to 50° C. and more preferably in a range of −20° C. to 40° C. From the viewpoint of easily forming an image having excellent adhesiveness to the ink receiving layer, it is preferable that the glass transition temperature of the urethane resin contained in the ink receiving layer is set to be in the above-described range.

As the urethane resin, commercially available products may be used and examples thereof include SUPERFLEX (registered trademark) 150HS and SUPERFLEX 470 (manufactured by DKS Co., Ltd.), HYDRAN (registered trademark) AP-20, HYDRAN WLS-210, and HYDRAN HW-161 (manufactured by DIC Corporation).

——Cross-Linking Agent——

It is preferable that the resin contained in the ink receiving layer is cross-linked. As a cross-linking agent cross-linking the resin contained in the ink receiving layer, block isocyanate is preferable.

Block Isocyanate

The block isocyanate is an isocyanate compound having a structure of sealing the isocyanate group with a blocking agent and is used as a thermally cross-linking curing agent. Examples of the blocking agent of the block isocyanate include bisulfates, a phenol-based compound such as phenol, cresol, or ethyl phenol, an alcohol-based compound such as propylene glycol monomethyl ether, ethylene glycol, benzyl alcohol, methanol, or ethanol, an active methylene-based compound such as dimethyl malonate, diethyl malonate, methyl acetoacetate, ethyl acetoacetate, or acetyl acetone, a mercaptan-based compound such as butyl mercaptan or dodecyl mercaptan, a lactam-based compound such as ε-caprolactam or δ-valerolactam, an amine-based compound such as diphenylaniline, aniline, ethylene imine, diisopropylamine, diisobutylamine, di(2-butylamine), di(t-butyl)amine, dicyclohexylamine, or N-t-butylcyclohexylamine, and an oxime-based compound such as acetanilide, an acid amide compound of amide acetate, formaldehyde, acetaldoxime, acetone oxime, methyl ethyl ketone oxime, or cyclohexanone oxime. The block isocyanate may be used alone or in combination of two or more kinds thereof.

Further, examples of the isocyanate compound forming block isocyanate include aromatic isocyanate such as tolylene diisocyanate, xylylene diisocyanate, methylene diphenyl diisocyanate, phenylene diisocyanate, or naphthalene diisocyanate; aliphatic isocyanate having an aromatic ring such as α,α,α′,α′-tetramethylxylylene diisocyanate; aliphatic isocyanate such as methylene diisocyanate, propylene diisocyanate, lysine diisocyanate, trimethyl hexamethylene diisocyanate, hexamethylene diisocyanate, tetramethylene diisocyanate, pentamethylene diisocyanate, 2,2,4-trimethyl-1,6-diisocyanatohexane; and alicyclic isocyanate such as cyclohexane diisocyanate, methyl cyclohexane diisocyanate, isophorone diisocyanate, methylene bis(4-cyclohexylisocyanate), isopropylidene dicyclohexyl diisocyanate, 1,3-bis(isocyanatomethyl)-cyclohexane, 4,4-dicyclohexylmethane diisocyanate, norbornene diisocyanate, or hydrogenated xylylene diisocyanate. Further, other examples thereof include polymers of a burette product of the isocyanate compound, an isocyanate product, an uretdione product, and carbodiimide-modified product, and derivatives of these. The isocyanate compound may be used alone or in combination of a plurality of kinds thereof. From the viewpoint of suppressing yellowing due to ultraviolet rays, among the isocyanurate compounds, aliphatic isocyanate or alicyclic isocyanate is more preferable than aromatic isocyanate.

In the ink receiving layer containing block isocyanate, a urethanization reaction proceeds between an isocyanate group (NCO group) derived from a block isocyanate compound and a hydroxyl group or the like in the system and the cross-linking density can be improved by dissociating a group derived from a blocking agent from the block isocyanate compound.

The weight-average molecular weight of the block isocyanate is preferably in a range of 300 to 10000. The lower limit thereof is more preferably 500 and more preferably 700. Further, the upper limit thereof is more preferably 9000, still more preferably 8500, and most preferably 8000.

The weight-average molecular weight is a value measured according to a method of the related art.

Typically, the thickness of the ink receiving layer is appropriately in a range of 0.03 to 5 μm, more preferably in a range of 0.04 μm to 2 μm, and particularly preferably in a range of 0.07 μm to 1 μm.

The ink receiving layer may contain a cross-linking agent other than the block isocyanate. In a case where the ink receiving layer contains a cross-linking agent, at least a part of the resin contained in the ink receiving layer is cross-linked, and the film hardness of the ink receiving layer is improved.

Examples of the cross-linking agent include a melamine compound, an epoxy compound, an oxazoline compound, an isocyanate compound, and a carbodiimide compound.

It is preferable that the cross-linking agent is at least one selected from an oxazoline compound, a carbodiimide compound, and an isocyanate compound.

Oxazoline Compound

The oxazoline compound is a compound having two or more oxazoline groups in a molecule.

As the oxazoline compound, a polymer that contains an oxazoline group, for example, a polymer obtained by copolymerizing a polymerizable unsaturated monomer containing an oxazoline group with a polymerizable unsaturated monomer other than the polymerizable unsaturated monomer containing an oxazoline group as necessary according to a known method (for example, solution polymerization or emulsion polymerization) can be exemplified. Examples of the polymerizable unsaturated monomer containing an oxazoline group include compounds containing 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, and the like as a monomer unit. Further, examples of commercially available products of the oxazoline compound include EPOCROS (registered trademark) K-2020E, EPOCROS (registered trademark) K-2010E, EPOCROS (registered trademark) K-2020E, EPOCROS (registered trademark) K-2030E, EPOCROS (registered trademark) WS-300, EPOCROS (registered trademark) WS-500, and EPOCROS (registered trademark) WS-700 (manufactured by NIPPON SHOKUBAI CO., LTD.).

Carbodiimide Compound

The carbodiimide compound is a compound containing a functional group represented by —N═C═N—. The polycarbodiimide is typically synthesized by a condensation reaction of organic diisocyanate, but an organic group of the organic diisocyanate used for the synthesis is not particularly limited, and any of aromatic organic diisocyanate and aliphatic organic diisocyanate or a mixture of aromatic organic diisocyanate and aliphatic organic diisocyanate can also be used. However, aliphatic organic diisocyanate is particularly preferable from a viewpoint of reactivity. As the raw material of synthesis, organic isocyanate, organic diisocyanate, organic triisocyanate, or the like is used.

Specifically, 4,4′-diphenylmethane diisocyanate, 4,4-diphenyldimethylmethane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethyl hexamethylene diisocyanate, 4,4′-dicyclohexylmethane diisocyanate, 1,3-phenyl ene diisocyanate, or the like is used. Further, as the organic monoisocyanate, isophorone isocyanate, phenyl isocyanate, cyclohexyl isocyanate, butyl isocyanate, naphthyl isocyanate, or the like is used. Further, examples of commercially available products of the carbodiimide compound include CARBODILITE (registered trademark) V-02-L2 (manufactured by Nisshinbo Holdings Inc.).

Isocyanate Compound

The isocyanate compound is a compound having a partial structure of —N═C═O. Examples of the organic isocyanate compound include aromatic isocyanate and aliphatic isocyanate, and a mixture of two or more kinds thereof may be used as the isocyanate compound. Specifically, 4,4′-diphenylmethane diisocyanate, 4,4-diphenyldimethylmethane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethyl hexamethylene diisocyanate, 4,4′-dicyclohexylmethane diisocyanate, 1,3-phenyl ene diisocyanate, or the like is used. Further, as the organic monoisocyanate, isophorone isocyanate, phenyl isocyanate, cyclohexyl isocyanate, butyl isocyanate, naphthyl isocyanate, or the like is used. Further, a commercially available product may be used as the isocyanate compound, and examples of the commercially available product include ERASTRON (registered trademark) H-3 and CAT-21 (both manufactured by DKS Co., Ltd.), DP9C214 (manufactured by Baxenden Chemical Ltd.), and TAKENATE (registered trademark) WD-HS30 (manufactured by Mitsui Chemicals, Inc.).

The content of the cross-linking agent is preferably in a range of 3% by mass to 30% by mass and more preferably in a range of 3% by mass to 20% by mass with respect to the total mass of the resin contained in the ink receiving layer.

In a case where the content of the cross-linking agent is 3% by mass or greater with respect to the content of the resin, the adhesiveness of the ink receiving layer to a layer adjacent to the ink receiving layer is improved and the film hardness of the ink receiving layer is improved. Further, the adhesiveness of the ink receiving layer to the aqueous ink used in a case of forming an image is also improved.

The ink receiving layer may further contain a surfactant, a lubricant, organic or inorganic particles, and a pH adjuster.

——Surfactant——

In a case where a coating solution used for forming an ink receiving layer contains a surfactant, the surfactant exerts an effect of improving the coating properties of the coating solution.

Examples of the surfactant include known anionic surfactants, non-ionic surfactants, cationic surfactants, fluorine-based surfactants, and silicone-based surfactants. The surfactant is described in, for example, “Surfactant Handbook” (edited by Ichiro Nishi, Ichiro Imai, and Masatake Kasai, Sangyo-Tosho Publishing Co., Ltd., published in 1960).

From the viewpoint of the excellent effect of improving the coating properties, an anionic surfactant and/or a non-ionic surfactant is particularly preferable as the surfactant contained in the ink receiving layer.

Examples of the anionic surfactant include a higher fatty acid salt such as potassium stearate or potassium behenate; alkyl ether carboxylate such as sodium polyoxyethylene (hereinafter, abbreviated as POE) lauryl ether carboxylate; N-acyl-L-glutamate such as N-stearoyl-L-glutamic acid monosodium salt; a higher alkyl sulfuric acid ester salt such as sodium lauryl sulfate or potassium lauryl sulfate; an alkyl ether sulfuric acid ester salt such as triethanolamine POE lauryl sulfate or sodium POE lauryl sulfate; N-acyl sarcosinate such as sodium lauryl sarcosine; higher fatty acid amide sulfonate such as sodium N-myristoyl-N-methyl taurine; alkyl phosphate such as sodium allyl phosphate; alkyl ether phosphate such as sodium POE oleyl ether phosphate or sodium POE stearyl ether phosphate; sulfosuccinate such as sodium di-2-ethylhexyl sulfosuccinate, sodium monolauroyl monoethanolamide polyoxyethylene sulfosuccinate, or sodium lauryl polypropylene glycol sulfosuccinate; alkyl benzene sulfonate such as sodium linear dodecyl benzene sulfonate, linear dodecyl benzene, sulfonic acid triethanolamine, linear dodecyl benzene sulfonate, or dodecyl diphenyl ether disulfonate; and a higher fatty acid ester sulfuric acid ester salt such as cured coconut oil fatty acid sodium glycerin sulfate.

Examples of the commercially available anionic surfactant include RAPISOL (registered trademark) A-90, RAPISOL (registered trademark) A-80, RAPISOL (registered trademark) BW-30, RAPISOL (registered trademark) B-90, RAPISOL (registered trademark) C-70 (manufactured by NOR CORPORATION); NIKKOL (registered trademark) OTP-100 (manufactured by NIKKO CHEMICAL CO., LTD.); Kohakuru (registered trademark) ON (manufactured by Toho Chemical Industry Co., Ltd.), Kohakuru (registered trademark) L-40 (manufactured by Toho Chemical Industry Co., Ltd.), Phosphanol 702 (manufactured by Toho Chemical Industry Co., Ltd.); Beaulight (registered trademark) A-5000, Beaulight (registered trademark) SSS, and Sandeddo (registered trademark) BL (manufactured by Sanyo Chemical Industries, Ltd.).

Examples of the cationic surfactant include an alkyl trimethyl ammonium salt such as stearyl trimethyl ammonium chloride or lauryl trimethyl ammonium chloride; a dialkyl dimethyl ammonium salt such as distearyl dimethyl ammonium chloride; an alkyl pyridinium salt such as poly(N,N-dimethyl-3,5-methylene piperidinium) chloride or cetyl pyridinium chloride; an alkyl quaternary ammonium salt, an alkyl dimethyl benzyl ammonium salt, an alkyl isoquinolinium salt, a dialkyl morifolium salt, POE alkylamine, an alkylamine salt, a polyamine fatty acid derivative, an amyl alcohol fatty acid derivative, benzalkonium chloride, and benzethonium chloride. By using the above-described surfactant, aggregation of particles during the drying process of a coated film is suppressed so that a uniform surface can be formed without unevenness.

Other examples of commercially available products of the cationic surfactant include a phthalocyanine derivative (trade name, EFKA-745, manufactured by MORISHITA & CO., LTD.), organosiloxane polymer KP341 (manufactured by Shin-Etsu Chemical Co., Ltd.), (meth)acrylic acid (co)polymer POLYFLOW No. 75, No. 90, and No. 95 (manufactured by KYOEISHA CHEMICAL Co., LTD.), and W001 (manufactured by Yusho Co., Ltd.).

Examples of the commercially available products of the non-ionic surfactant include NAROACTY (registered trademark) CL-95, HN-100 (manufactured by Sanyo Chemical Industries Co., Ltd.), LITHO REX (registered trademark) BW400 (manufactured by KOKYU ALCOHOL KOGYO CO., LTD.), EMALEX (registered trademark) ET-2020 (manufactured by Nihon Emulsion Co., Ltd.), UNILUBE (registered trademark) 50 MB-26, and NONION (registered trademark) IS-4 (manufactured by NOF CORPORATION).

In a case where the coating solution for forming an ink receiving layer contains a surfactant, the amount of the surfactant is preferably in a range of 0.5% by mass to 5.0% by mass and more preferably in a range of 0.5% by mass to 3.0% by mass with respect to the total mass of the solid content in the resin.

——Lubricant——

In the ink receiving layer that contains a lubricant, the aqueous ink for forming an image on the surface of the ink receiving layer is unlikely to blur on the surface of the ink receiving layer, and thus an image with a high resolution is formed compared to the ink receiving layer that does not contain a lubricant.

As the lubricant, an aliphatic wax or the like is preferably used.

Specific examples of the aliphatic wax include a vegetable wax such as carnauba wax, candelilla wax, rice wax, Japan wax, jojoba oil, palm wax, rosin-modified wax, ouricury wax, sugar cane wax, esparto wax, or bark wax; an animal wax such as bees wax, lanolin, whale wax, insect wax, or shellac wax; a mineral wax such as montan wax, ozocerite, or ceresin wax; a petroleum-based wax such as paraffin wax, microcrystalline wax, or petrolactam wax; and a synthetic hydrocarbon-based wax such as Fischer-Tropsch wax, polyethylene wax, polyethylene oxide wax, polypropylene wax, or polypropylene oxide wax. Among these, carnauba wax, paraffin wax, or polyethylene wax is particularly preferable.

The lubricant can be used as a water dispersion because of a small environmental load and excellent handleability. Examples of commercially available products of the lubricant include CELLOSOL (registered trademark) 524 (manufactured by CHUKYO YOSHI CO., LTD.).

The lubricant may be used alone or in combination of two or more kinds thereof.

The content of the lubricant is preferably in a range of 0.005% by mass to 10% by mass and more preferably in a range of 0.01% by mass to 5% by mass with respect to the total mass of the solid content in the ink receiving layer.

——Organic or Inorganic Particles——

Examples of the inorganic particles include silica, calcium carbonate, magnesium oxide, and magnesium carbonate.

Examples of the organic particles include polystyrene particles and polymethyl methacrylate particles. From the viewpoints of the cost and the effect of improving slipping properties, polystyrene particles, polymethyl methacrylate particles, and silica are preferable.

——pH Adjuster——

Examples of the pH adjuster include phosphoric acid, citric acid, sodium acetate, sodium hydrogen carbonate, gluconic acid, adipic acid, succinic acid, tartaric acid, potassium carbonate, lactic acid, sodium lactate, glacial acetic acid, acetic acid, fumaric acid, and malic acid.

˜Formation of Ink Receiving Layer˜

The ink receiving layer can be formed by preparing a coating solution for forming an ink receiving layer and coating one surface of the resin layer with the coating solution. Examples of the coating method include a bar coating method, a slit coating method, a spray coating method, and a spin coating method.

˜Preferred Forms of Transparent Resin Base Material˜

From the viewpoint that the effects are markedly exerted, it is preferable that the transparent resin base material is used for applications severely requiring the dimensional accuracy. Examples of the above-described applications include lenticular applications, optical prism applications, and light-guiding plate applications. Examples of the forms of the transparent resin base material include a lenticular sheet and a prism.

The lenticular sheet used for the lenticular applications is a laminate including a resin layer and a lens layer and is required to have high dimensional accuracy because of the applications and display physical properties. Specifically, an image (parallax picture) is disposed on a side of the lenticular sheet opposite to a side where the lens layer is disposed on the resin layer. In a case where the lens layer and the parallax picture are in a specific positional relationship, the display content is switched depending on the viewing direction. Accordingly, there is a concern that a desired image cannot be obtained in a case where the above-described positional relationship is deviated due to the deformation or the like of the sheet.

—Lenticular Sheet—

The lenticular sheet includes a resin layer and a lens layer.

It is preferable that the lenticular sheet includes the lens layer on one surface of the resin layer and the ink receiving layer on the other side of the resin layer.

It is preferable that the lenticular sheet includes a resin layer that is stretched in at least one direction and more preferable that the lenticular sheet includes a resin layer that is biaxially stretched. In a case where the resin layer is stretched in at least one direction, the heat resistance of the lenticular sheet is improved, and deformation caused by heating in the drying step described below can be further suppressed.

The stretching direction and the preferable conditions are as described above.

In a case where the lenticular sheet includes the ink receiving layer, the ink receiving layer may be laminated on a surface of the resin layer on a side opposite to a side where the lens layer is disposed after the lens layer is laminated on the resin layer. Alternatively, the lens layer may be laminated on a surface of the resin layer on a side opposite to a side where the ink receiving layer is disposed after the ink receiving layer is laminated on the resin layer. The details of the lens layer will be described in detail.

The following embodiment is preferable in a case where the lenticular sheet includes the ink receiving layer and the lens layer is laminated on a surface of the resin layer on a side opposite to a side where the ink receiving layer is disposed after the ink receiving layer is laminated on the resin layer.

It is preferable that the lenticular sheet including the ink receiving layer includes a stretched laminate that has a resin layer stretched in at least one direction and an ink receiving layer, which is obtained by stretching an unstretched laminate having an ink receiving layer on one surface side of an unstretched resin layer or a resin layer stretched in a first direction.

It is preferable that the lenticular sheet includes the lens layer on a surface of the resin layer in the stretched laminate on a side opposite to a side where the ink receiving layer is provided.

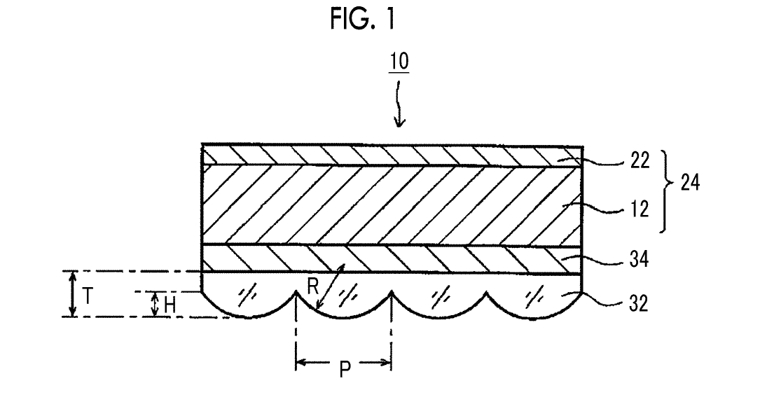

Specifically, as illustrated in FIG. 1, it is preferable that a lenticular sheet 10 having a layer structure includes an ink receiving layer 22 on one surface of a resin layer 12; and a lens layer 32 on the other surface of the resin layer 12. The resin layer 12 and the lens layer 32 may be laminated on each other through an interlayer 34. Further, it is preferable that a stretched laminate 24 is formed of the resin layer 12 and the ink receiving layer 22.

It is preferable that the lenticular sheet includes a stretched laminate as described above.

In a case where the lenticular sheet includes a stretched laminate, the adhesiveness between the resin layer and the ink receiving layer is excellent compared to a case where the lenticular sheet includes an unstretched laminate.

The adhesiveness between the resin layer and the ink receiving layer tends to be degraded as the thickness of the lenticular sheet decreases, for example, 400 μm or less, 350 μm or less, and 200 μm or less. However, in a case where such a thin lenticular sheet includes a stretched laminate, the adhesiveness between the resin layer and the ink receiving layer becomes excellent.

——Unstretched Laminate——

It is preferable that the unstretched laminate is prepared by coating one surface side of the unstretched resin layer or the resin layer stretched in the first direction with a coating solution for forming an ink receiving layer to provide a coating layer.

——Unstretched Resin Layer or Resin Layer Stretched in First Direction——

It is preferable that the resin as a material of the unstretched resin layer or the resin layer stretched in the first direction used for the unstretched laminate is a resin which is transparent to light in a visible region and is resistant to the heating temperature during formation of the lens layer. Preferred examples of the resin include polyester such as polyethylene terephthalate or polyethylene naphthalate, polycarbonate, polysulfone, or wholly aromatic polyamide. Particularly from the viewpoint of easily forming a resin layer having excellent smoothness, polyester is preferable and polyethylene terephthalate is more preferable.

It is preferable that the unstretched resin layer or the resin layer stretched in the first direction used for the unstretched laminate is produced by melting and extruding or stretching the resin for film formation. As the resin layer used for the unstretched laminate, uniaxially stretched polyethylene terephthalate is particularly preferable.

The thermal shrinkage at the time of heating the resin layer at 150° C. for 30 minutes is preferably in a range of 0.0%±0.6%, more preferably in a range of 0.0%±0.4%, and still more preferably in a range of 0.0%±0.3%.

In a case where the thermal shrinkage is in a range of 0.0%±0.6%, the deformation of the lenticular sheet caused by heat generated when the aqueous ink is dried is further suppressed.

The thickness of the resin layer used for the unstretched laminate is determined depending on the stretching ratio at the time of preparing the stretching laminate. Specifically, the thickness thereof is preferably in a range of 25 μm to 250 μm, more preferably in a range of 50 μm to 250 μm, and particularly preferably in a range of 100 μm to 250 μm.

——Coating Layer——

One surface side of the resin layer which is unstretched or stretched in the first direction is coated with a coating solution for forming an ink receiving layer to form a coating layer, thereby preparing an unstretched laminate.

The surface side of the resin layer to be coated with the coating solution for forming an ink receiving layer may be subjected to a corona discharge treatment in advance because adhesive strength between the resin layer and the ink receiving layer can be increased.

[Coating Solution for Forming Ink Receiving Layer]

The coating solution for forming an ink receiving layer contains the solid content forming the ink receiving layer and a coating vehicle.

The description of the ink receiving layer in the lenticular sheet is the same as that for the ink receiving layer of the transparent resin base material described above, and the preferred forms such as the thickness and the physical properties thereof are the same as described above.

——First Interlayer——

A first interlayer containing a resin may be provided between the resin layer and the ink receiving layer. By providing the first interlayer, the adhesiveness between the resin layer and the ink receiving layer can be increased.

Examples of the resin contained in the first interlayer include an ethylene-vinyl alcohol copolymer and modified polyolefin such as modified polyethylene or modified polypropylene.

The modified polyolefin is commercially available under the name of ADMER (registered trademark) (manufactured by Mitsui Chemicals, Inc.).

The first interlayer may be provided on a surface of the resin layer depending on the characteristics of the resin according to an appropriate method. The first interlayer may be formed by coating the surface of the resin layer with a solution formed by dissolving a resin in a vehicle or a dispersion liquid formed by dispersing a resin in a vehicle. Alternatively, in a case where the resin is thermally meltable, the first interlayer may be formed by melting and extruding the resin on the surface of the resin layer.

——Stretched Laminate——

The stretched laminate is prepared by stretching the unstretched laminate.

As the method of preparing the stretched laminate by stretching the unstretched laminate, a method of stretching the unstretched laminate in one direction and stretching the stretched laminate in a direction orthogonal to the one direction is preferable.

As a preferable embodiment of the lenticular sheet, an embodiment in which a uniaxially stretched film is obtained by stretching the resin layer contained in the unstretched laminate in the first direction and the stretching is made in a direction in which at least one stretching direction where the unstretched laminate is stretched is orthogonal to the first direction of the uniaxially stretched film is exemplified.

The stretching ratio in a case where the stretched laminate is prepared from the unstretched laminate is preferably in a range of 1.5 times to 7 times, more preferably in a range of 1.7 times to 5 times, and still more preferably in a range of 2 times to 4 times. In a case where the stretching ratio is in a range of 1.5 times to 7 times, improved lenticular sheet in which the mechanical strength is sufficient, the uniformity of the thickness is excellent, and the adhesiveness between the resin layer and the ink receiving layer is excellent is easily obtained.

In a case where the resin layer contained in the unstretched laminate is a uniaxially stretched film, it is advantageous that the stretching direction of the uniaxially stretched film is set as an MD and the stretching direction of stretching the unstretched laminate is set as a TD from the viewpoint that the degree of freedom in manufacture is large.

The lens layer is provided on a side of the obtained stretched laminate opposite to a side where the ink receiving layer is provided, thereby obtaining a lenticular sheet.

The thickness of the resin layer in the stretched laminate is preferably in a range of 50 μm to 300 μm, more preferably in a range of 60 μm to 300 μm, and particularly preferably in a range of 100 μm to 300 μm.

The thickness of the ink receiving layer in the stretched laminate is preferably in a range of 0.01 μm to 1 μm, more preferably in a range of 0.02 μm to 0.1 μm, and particularly preferably in a range of 0.04 μm to 0.07 μm.

——Lens Layer——

The lens layer (hereinafter, also referred to as the “lenticular lens layer”) is formed on a surface of the resin layer in the stretched laminate on a side opposite to a surface side where the ink receiving layer is provided.

As illustrated in FIG. 1, the lens layer may be provided through the interlayer 34 (second interlayer).

It is preferable that the lens layer 32 and the interlayer 34 are formed according to a method of melting and coextruding resins used for each of the interlayer 34 and the lens layer 32 on a surface of the resin layer in the stretched laminate on a side opposite to a side where the ink receiving layer is provided, embossing the surface of the resin for forming the lens layer 32 using an embossing roller to form the lens layer 32.

Further, the interlayer 34 may be formed by forming a coating layer on a surface side of the unstretched resin layer or the resin layer stretched in the first direction on a side opposite to a side where the ink receiving layer is formed while the unstretched laminate is prepared and stretching the obtained unstretched laminate that includes a coating layer respectively on both surfaces of the unstretched resin layer or the resin layer stretched in the first direction.

Examples of the resin forming the lens layer 32 include a polymethyl methacrylate resin (PMMA), a polycarbonate resin, a polystyrene resin, a methacrylate-styrene copolymer resin (MS resin), an acrylonitrile-styrene copolymer resin (AS resin), a polypropylene resin, a polyethylene resin, a polyethylene terephthalate (PET) resin, a glycol-modified polyethylene terephthalate (PET-G) resin, a polyvinyl chloride resin (PVC), a thermoplastic elastomer, and a cycloolefin polymer. From the viewpoint of ease of performing melt extrusion, it is preferable to use a resin having a low melt viscosity such as a polymethyl methacrylate resin (PMMA), a polycarbonate resin, a polystyrene resin, a methacrylate-styrene copolymer resin (MS resin), a polyethylene resin, a polyethylene terephthalate (PET) resin, or a glycol-modified polyethylene terephthalate (PET-G) resin. Since the lens shape formed on the surface of the embossing roller is easily transferred and cracks are unlikely to occur in the lens layer at the time of embossing, it is more preferable to use a glycol-modified polyethylene terephthalate (PET-G) resin.

Further, as the polyethylene terephthalate (PET) resin, amorphous PET (A-PET) may be used.

Further, the lens layer 32 may contain a plurality of resins.

The lens layer 32 has a thickness (T in FIG. 1) of 50 μm to 200 μm and has a lenticular lens shape in which a plurality of convex lenses in a cylindrical shape are arranged in parallel on the surface. It is preferable that the lenticular lens shape is formed by setting the lens radius (R in FIG. 1) to be in a range of 100 μm to 200 μm, the lens height (H in FIG. 1) to be in a range of 50 μm to 100 μm, and the lens pitch (P in FIG. 1) to be in a range of 100 μm to 257 μm. However, the lens pitch is not limited to the above-described numerical values, and values such as 127 μm and 254 μm may be exemplified. The lenticular lens shape indicates a plate-like lens array in which the shapes obtained by vertically dividing a column are vertically arranged in parallel, that is, a shape in which cylindrical lenses are two-dimensionally arranged.

——Second Interlayer——

The interlayer 34 may be provided, as the second interlayer, between the resin layer 12 and the lens layer 32. In a case where the resin material constituting the lens layer 32 has adhesiveness to the resin layer 12, the second interlayer 34 is not necessarily provided.

It is preferable that the second interlayer 34 contains at least a resin. As the resin forming the second interlayer 34, a thermoplastic resin having excellent adhesiveness to the lens layer 32 and the resin layer 12 is preferable.

Suitable examples of the thermoplastic resin forming the second interlayer 34 include an ethylene-vinyl alcohol copolymer, modified polyolefin such as modified polyethylene or modified polypropylene, polyester, an acrylic resin, and a urethane resin.

The thickness of the second interlayer 34 is preferably greater than 0 μm and 10 μm or less and more preferably greater than 0 μm and 0.1 μm or less.

Next, the method of forming each of the second interlayer 34 and the lens layer 32 on a surface of the resin layer in the stretched laminate 24 on a side opposite to a side where the ink receiving layer 22 is provided will be described.

It is preferable that method includes a step of coextruding a first thermoplastic resin for forming the second interlayer 34 and a second thermoplastic resin for forming the lens layer 32 on a side of the resin layer 12 opposite to a side where the ink receiving layer 22 is provided; and a step of pressing the stretched laminate, on which the coextruded first thermoplastic resin layer and second thermoplastic resin layer are provided, between an embossing roller having a mold for forming a lens disposed by being directed to the second thermoplastic resin side and a nip roller disposed by being directed to the ink receiving layer 22 side of the resin layer 12 and processing the surface of the second thermoplastic resin layer to form a lens.

Further, the second interlayer 34 may be provided on a side of the resin layer 12 in the stretched laminate 24 opposite to a side where the ink receiving layer 22 is provided in advance. In other words, in a case where the method includes a laminate forming step of coating one surface side of the unstretched resin layer or the resin layer stretched in the first direction with a coating solution for forming an ink receiving layer and coating the other surface side of the resin layer with a coating solution for forming a second interlayer to form a laminate that includes a resin layer and a coating layer respectively on both surfaces of the resin layer; and a laminate stretching step of stretching the laminate, forming an ink receiving layer on one surface side of the resin layer stretched in at least on direction, and forming a second interlayer on the other surface side of the resin layer stretched in at least one direction, the stretched laminate is prepared and a lens layer can be formed on the second interlayer of the prepared stretched laminate.

For example, an inverted shape for forming the lenticular lens shape is formed on the surface of the embossing roller. The laminated layer formed by laminating two layers which are the first thermoplastic resin and the second thermoplastic resin coextruded on the surface of the resin layer of the stretched laminate is pressed between the embossing roller and the nip roller so that the inverted shape of the lens formed on the surface of the embossing roller is transferred to the surface of the laminated layer of the second thermoplastic resin. The laminated layer of the second thermoplastic resin to which the lenticular lens shape has been transferred is cooled and solidified while being wound around the embossing roller. Next, by the lenticular lens layer 32 having a lenticular lens is formed on the surface of the laminated layer of the second thermoplastic resin and a lenticular sheet is obtained by peeling the stretched laminate, which includes the laminated layer formed by laminating two layers which are the first thermoplastic resin and the second resin, from the embossing roller.

As the material of the embossing roller, various steel members, stainless steel, copper, zinc, brass, a material on which plating such as hard chromium plating (HCr plating), copper (Cu) plating, or nickel (Ni) plating is performed using any of these metal materials as a core metal, ceramics, and various composite materials can be employed.

Further, the nip roller is a roller which is disposed by being directed to the embossing roller and presses a resin layer or a resin layer and a transparent thermoplastic resin with the embossing roller. As the material of the nip roller, various steel members, stainless steel, copper, zinc, brass, and a material formed by performing rubber lining on the surface using any of these metal materials as a core metal can be employed.

The temperature of the embossing roller is set such that the temperature of the second thermoplastic resin in the portion where the laminate is pressed is set to higher than or equal to the glass transition temperature. This setting is made in order for the laminated layer of the second thermoplastic resin not to be cooled or solidified until the transfer of the mold to the surface of the laminated layer is completed.

It is appropriate that the thickness of the lenticular sheet is in a range of 30 μm to 400 μm. A thin lenticular sheet having relatively high manufacturing difficulty in terms of mechanical strength or image recognizability, for example, a lenticular sheet having a thickness of 100 μm to 200 μm can be easily obtained using the above-described method.

As illustrated in the schematic cross-sectional view of FIG. 1, it is preferable that the lenticular sheet includes the stretched laminate 24, the lenticular lens layer 32, and the interlayer 34.

The stretched laminate 24 includes the resin layer 12 and the ink receiving layer 22. As described above, the stretched laminate 24 is prepared by coating one surface side of the resin layer with the coating solution for forming an ink receiving layer, preparing the unstretched laminate including the resin layer and the coating layer, and stretching the unstretched laminate. Accordingly, the resin layer 12 and the ink receiving layer 22 which are included in the stretched laminate 24 are simultaneously stretched.

(Treatment Liquid)

The treatment liquid contains at least one acidic compound. The acidic compound in the treatment liquid allows the components contained in the aqueous ink to be aggregated by bringing the treatment liquid and the aqueous ink into contact with each other on the transparent resin base material.

—Acidic Compound—

As the acidic compound, an acidic substance capable of lowering the pH of the aqueous ink is exemplified.

As the acidic compound, any of an organic acidic compound and an inorganic acidic compound may be used and two or more organic acidic compounds and inorganic acidic compounds may be used in combination.

——Organic Acidic Compound——

Examples of the organic acidic compound include organic compounds containing an acidic group.

Examples of the acidic group include a phosphoric acid group, a phosphonic acid group, a phosphinic acid group, a sulfuric acid group, a sulfonic acid group, a sulfinic acid group, and a carboxy group. From the viewpoint of the aggregation rate of the aqueous ink, it is preferable that the acidic group according to the embodiment of the present invention is a phosphoric acid group or a carboxy group and more preferable that the acidic group is a carboxy group.

Preferred examples of the organic compound (organic carboxylic acid) containing a carboxy group include polyacrylic acid, acetic acid, glycolic acid, malonic acid, malic acid (preferably DL-malic acid), maleic acid, ascorbic acid, succinic acid, glutaric acid, fumaric acid, citric acid, tartaric acid, phthalic acid, 4-methylphthalic acid, lactic acid, sulfonic acid, orthophosphoric acid, pyrrolidone carboxylic acid, pyrrone carboxylic acid, pyrrole carboxylic acid, furan carboxylic acid, pyridine carboxylic acid, coumarinic acid, thiophene carboxylic acid, nicotinic acid, propanetricarboxylic acid, derivatives of these compounds, and salts of these (for example, polyvalent metal salts). The organic compound having a carboxy group may be used alone or in combination of two or more kinds thereof.

From the viewpoint of the aggregation rate of the aqueous ink, as the organic carboxylic acid, di- or higher valent carboxylic acid (hereinafter, also referred to as polyvalent carboxylic acid) is preferable; at least one selected from malonic acid, malic acid, maleic acid, succinic acid, glutaric acid, fumaric acid, tartaric acid, 4-methylphthalic acid, and citric acid is more preferable; and at least one selected from malonic acid, malic acid, and propanetricarboxylic acid is still more preferable.

It is preferable that the pKa of the organic acidic compound is low.

In this manner, the surface charge of particles such as polymer particles or the pigment stably dispersed in the aqueous ink by a weakly acidic functional group such as a carboxy group is reduced by bringing the aqueous ink into contact with an organic acidic compound having a lower pKa to decrease the dispersion stability.

It is preferable that the organic acidic compound contained in the treatment liquid is a compound which has a low pKa and a high solubility in water and is di- or higher valent and more preferable that the organic acidic compound is a di- or trivalent acidic substance which has a high buffer capacity in a pH region whose pKa is lower than the pKa of the functional group (for example, a carboxy group) that allows particles to be stably dispersed in the aqueous ink.

——Inorganic Acidic Compound——

Examples of the inorganic acidic compound include phosphoric acid, nitric acid, nitrous acid, sulfuric acid, and hydrochloric acid, but the inorganic acidic compound is not particularly limited thereto. From the viewpoints of the aggregation rate of the aqueous ink and suppressing occurrence of gloss unevenness in an image area, phosphoric acid is most preferable as the inorganic acidic compound.

The solubility (25° C.) of phosphoric acid in water in a case where a calcium salt (calcium phosphate) is obtained is 0.0018 g/100 g of water, which is small. Therefore, in a case where the inorganic acidic compound contained in the treatment liquid is phosphoric acid, the calcium salt is not dissolved and is immobilized so that the effect of suppressing gloss unevenness occurring on the surface of the image area becomes excellent.

The total amount of the acidic compound contained in the treatment liquid is not particularly limited, but is preferably in a range of 5% by mass to 40% by mass and more preferably in a range of 10% by mass to 30% by mass with respect to the total amount of the treatment liquid, from the viewpoint of the aggregation rate of the aqueous ink.

In a case where a combination of an organic acidic compound and an inorganic acidic compound is used as the acidic compound, in the content ratio between the organic acidic compound and the inorganic acidic compound, from the viewpoints of the aggregation rate and suppressing the gloss unevenness, the content ratio of the content of the inorganic acidic compound to the content of the organic acidic compound is preferably in a range of 5% by mole to 50% by mole, more preferably in a range of 10% by mole to 40% by mole, and still more preferably in a range of 15% by mole to 35% by mole.

As necessary, the treatment liquid may contain other aggregation components such as polyvalent metal salts and cationic polymers in addition to the acidic compounds.

Polyvalent metal salts and cationic polymers described in paragraphs 0155 and 0156 of JP2011-042150A can be used as the polyvalent metal salts and the cationic polymers.

—Water—

It is preferable that the treatment liquid contains water.

The content of water is preferably in a range of 50% by mass to 90% by mass and more preferably in a range of 60% by mass to 80% by mass with respect to the total mass of the treatment liquid.

—Water-Soluble Solvent—

It is preferable that the treatment liquid contains at least one water-soluble solvent.

In the present specification, the term “water-soluble” indicates a property in which a substance is dissolved in water at a certain concentration or greater. It is preferable that the term “water-soluble” indicates a property in which 5 g or greater (more preferably 10 g or greater) of a substance is dissolved in 100 g of water at 25° C.

Examples of the water-soluble solvent include derivatives of glycols such as glycerin, 1,2,6-hexanetriol, trimethylolpropane, ethylene glycol, and propylene glycol, polyalkylene glycol such as diethylene glycol, triethylene glycol, tetraethylene glycol, pentaethylene glycol, and dipropylene glycol, and polyalkylene glycols such as diethylene glycol monoalkyl ether, triethylene glycol monoalkyl ether, dipropylene glycol, tripropylene glycol monoalkyl ether, polyoxypropylene glyceryl ether, and polyoxyethylene polyoxypropylene glycol; polyhydric alcohols, for example, alkanediol such as 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; and saccharides, sugar alcohols, hyaluronic acids, alkyl alcohols having 1 to 4 carbon atoms, glycol ethers, 2-pyrrolidone, and N-methyl-2-pyrrolidone described in paragraph 0116 of JP2011-42150A. The water-soluble solvent can be used by appropriately selecting one or two or more kinds among the above-described solvents. Polyhydric alcohols are useful as a drying inhibitor and a wetting agent, and examples thereof include those described in paragraph 0117 of JP2011-42150A. Further, other examples of the water-soluble solvent include a polyol compound and an aliphatic diol. In addition, the polyol compound is preferable as a penetration enhancer, and examples of the aliphatic diol include those described in paragraph 0117 of JP2011-42150A.

Further, other water-soluble solvents can be appropriately selected from among water-soluble solvents described in paragraphs 0176 to 0179 of JP2011-46872A and water-soluble solvents described in paragraphs 0063 to 0074 of JP2013-18846A.

Among those, from the viewpoint of the balance between the water solubility and the boiling point, as the water-soluble solvent, polyalkylene glycol or a derivative thereof is preferable; and at least one selected from diethylene glycol monoalkyl ether, triethylene glycol monoalkyl ether, dipropylene glycol, tripropylene glycol monoalkyl ether, polyoxypropylene glyceryl ether, and polyoxyethylene polyoxypropylene glycol is more preferable.

From the viewpoint of coating properties, the content of the treatment liquid in the water-soluble solvent in the treatment liquid is preferably in a range of 3% by mass to 20% by mass and more preferably in a range of 5% by mass to 15% by mass with respect to the total content of the treatment liquid.

—Other Components—

The treatment liquid may contain components other than those described above as necessary.

Other components which can be contained in the treatment liquid are the same as other components which can be contained in the aqueous ink described below.

——Water-Soluble Polymer Compound——

The treatment liquid may contain at least one water-soluble polymer compound.

The water-soluble polymer compound is not particularly limited, and known water-soluble polymer compounds such as polyvinyl alcohol, polyacrylamide, polyvinylpyrrolidone, and polyethylene glycol can be used.

Further, specific polymer compounds described below and water-soluble polymer compounds described in paragraphs 0026 to 0080 of JP2013-001854A are also suitable as the water-soluble polymer compound.

The weight-average molecular weight of the water-soluble polymer compound is not particularly limited, but can be set to a range of 10000 to 100000, preferably in a range of 20000 to 80000, and more preferably in a range of 30000 to 80000.

As the weight-average molecular weight, a value measured according to the above-described method is employed.

Further, the content of the water-soluble polymer compound in the treatment liquid is not particularly limited, but is preferably in a range of 0.1% by mass to 10% by mass, more preferably in a range of 0.1% by mass to 4% by mass, still more preferably in a range of 0.1% by mass to 2% by mass, and even still more preferably in a range of 0.1% by mass to 1% by mass with respect to the total amount of the treatment liquid.

In a case where the content of the water-soluble polymer compound in the treatment liquid is 0.1% by mass or greater, the spreading of ink droplets can be further promoted. In a case where the content thereof is 10% by mass or less, the thickening of the treatment liquid can be further suppressed. Further, in a case where the content of the water-soluble polymer compound in the treatment liquid is 10% by mass or less, coating unevenness of the treatment liquid caused by bubbles in the treatment liquid can be further suppressed.

A polymer compound (hereinafter, also referred to as “specific polymer compound”) which has a hydrophilic structural unit having an ionic group (preferably an anionic group) is preferable as the water-soluble polymer compound. In this manner, the spreading of ink droplets applied to the transparent resin base material can be more promoted so that image roughness is further suppressed.

Examples of the ionic group contained in the specific polymer compound include a carboxy group, a sulfonic acid group a phosphoric acid group, a boronic acid group, an amino group, an ammonium group, and salts of these. Among these, a carboxy group, a sulfonic acid group, a phosphoric acid group, and salts of these are preferable; a carboxy group, a sulfonic acid group, and salts of these are more preferable; and a sulfonic acid group and a salt thereof are still more preferable.

As a hydrophilic structural unit having an ionic group (preferably an anionic group), a structural unit derived from a (meth)acrylamide compound having an ionic group (preferably an anionic group) is preferable.

The content of the hydrophilic structural unit having an ionic group (preferably an anionic group) in the water-soluble polymer compound can be set to be in a range of 10% by mass to 100% by mass and is preferably in a range of 10% by mass to 90% by mass, more preferably in a range of 10% by mass to 70% by mass, still more preferably in a range of 10% by mass to 50% by mass, and particularly preferably in a range of 20% by mass to 40% by mass with respect to the total mass of the water-soluble polymer compound.

It is more preferable that the specific polymer compound contains at least one hydrophilic structural unit in addition to at least one hydrophobic structural unit having the above-described ionic group (preferably an anionic group and particularly preferably a sulfonic acid group). Since the specific polymer compound is easily present on the surface of the treatment liquid in a case where the specific polymer compound has a hydrophobic structural unit, the spreading of ink droplets applied to the transparent resin base material is further promoted so that the image roughness is further suppressed.

As the hydrophobic structural unit, a structural unit derived from (meth)acrylic acid ester (preferably an alkyl ester in which the number of carbon atoms in (meth)acrylic acid is in a range of 1 to 4) is preferable.

The content of the hydrophobic structural unit in the specific polymer compound is in a range of 10% by mass to 90% by mass, preferably in a range of 30% by mass to 90% by mass, more preferably in a range of 50% by mass to 90% by mass, and still more preferably in a range of 60% by mass to 80% by mass with respect to the total mass of the specific polymer compound.

——Surfactant——

The treatment liquid may contain at least one surfactant.

The surfactant can be used as a surface tension adjuster. Examples of the surface tension adjuster include a non-ionic surfactant, a cationic surfactant, an anionic surfactant, and a betaine surfactant. Among these, from the viewpoint of the aggregation rate of the aqueous ink, a non-ionic surfactant or an anionic surfactant is preferable.

Examples of the surfactant include compounds exemplified as surfactants in pp. 37 and 38 of JP1984-157636A (JP-S59-157636A) and Research Disclosure No. 308119 (1989). Further, other examples of the surfactant include fluorine-based surfactants (fluorinated alkyl-based surfactants) and silicone-based surfactants described in JP2003-322926A, JP2004-325707A, and JP2004-309806A.

The content of the surfactant in the treatment liquid is not particularly limited, but the content can be set such that the surface tension of the treatment liquid becomes preferably 50 mN/m or less, more preferably in a range of 20 mN/m to 50 mN/m, and still more preferably in a range of 30 mN/m to 45 mN/m.

˜Physical Properties of Treatment Liquid˜

From the viewpoint of the aggregation rate of the aqueous ink, the pH of the treatment liquid at 25° C. (±1° C.) is preferably in a range of 0.1 to 0.5.

In a case where the pH of the treatment liquid is 0.1 or greater, the roughness of the transparent resin base material is further decreased and the adhesiveness of the image area is further improved.

In a case where the pH of the treatment liquid is 0.5 or less, the aggregation rate of the components contained in the aqueous ink is further improved, coalescence of dots (ink dots) caused by the aqueous ink on the transparent resin base material is further suppressed, and the roughness of the image is further decreased.

The pH (25° C.±1° C.) of the treatment liquid is more preferably in a range of 0.2 to 0.4.

From the viewpoint of the aggregation rate of the aqueous ink, the viscosity of the treatment liquid is preferably in a range of 0.5 mPa·s to 10 mPa·s and more preferably in a range of 1 mPa·s to 5 mPa·s. The viscosity is a value measured using A VISCOMETER TV-22 (manufactured by TOKI SANGYO CO., LTD.) under a temperature condition of 25° C.

The surface tension of the treatment liquid at 25° C. (±1° C.) is preferably 60 mN/m or less, more preferably in a range of 20 mN/m to 50 mN/m, and still more preferably in a range of 30 mN/m to 45 mN/m. The surface tension of the treatment liquid is measured using an Automatic Surface Tensiometer CBVP-Z (manufactured by Kyowa Interface Science Co., Ltd.) according to a plate method.

˜Application Method˜

The method of applying the treatment liquid in the treatment liquid applying step is not particularly limited. And examples of the method of applying the treatment liquid include application methods using an ink jet system; and known coating methods using an extrusion die coater, an air doctor coater, a blade coater, a rod coater, a knife coater, a squeeze coater, a reserve roll coater, a bar coater, and the like.

[Ink Jetting Step]

The method of producing a transparent resin base printed material of the present disclosure includes an ink jetting step of jetting an aqueous ink, which contains a colorant, resin particles, water, and a solvent having a boiling point of 150° C. to 250° C. and in which the content of a solvent having a boiling point of higher than 250° C. is 1% by mass or less, onto the transparent resin base material to which the treatment liquid has been applied according to an ink jet system.

(Aqueous Ink)

The aqueous ink contains a colorant, resin particles, water, and a solvent having a boiling point of 150° C. to 250° C., and the content of a solvent having a boiling point of higher than 250° C. is 1% by mass or less with respect to the total mass of the ink.

The aqueous ink may contain other components as necessary. Examples of other components include surfactants, colloidal silica, urea, water-soluble polymer compounds, antifoaming agents, inorganic salts, and wax particles.

The boiling point can be acquired using a boiling point measuring device (boiling point measuring device DosaTherm 300, manufactured by Titan Technologies Inc.).

—Solvent Having Boiling Point of 150° C. to 250° C.—

In a case where the aqueous ink contains at least one solvent having a boiling point of 150° C. to 250° C., the solvent is unlikely to remain after the aqueous ink is dried and the fixing properties of the image are excellent even in a case where the drying temperature in the drying step described below is set to be in a predetermined range. Since the drying temperature in the drying step described below can be set to be lower than that of an aqueous ink of the related art, thermal deformation of the transparent resin base material can be suppressed.

In a case where the boiling point of a solvent is 150° C. or higher, the aqueous ink has excellent jettability and dispersion stability. Meanwhile, in a case where the boiling point of a solvent is 250° C. or lower, the solvent is unlikely to remain after the aqueous ink is dried and the fixing properties of the image are excellent.

From the above-described viewpoint, the boiling point thereof is preferably in a range of 150° C. to 230° C., more preferably in a range of 150° C. to 220° C., and still more preferably in a range of 150° C. to 200° C.

As a solvent having a boiling point of 150° C. to 250° C., glycol ether or a pyrrolidone compound is preferable; and ethylene glycol ether or propylene glycol ether is more preferable.

Examples of the solvent having a boiling point of 150° C. to 250° C. include compounds listed in Table 1.

These solvents can be used by appropriately selecting one or two or more kinds thereof.

TABLE 1

| Solvent having boiling point of 150° C. to 250° C. | Boiling point |
|---|---|
| Ethyl lactate | 155° C. |
| Diethylene glycol dimethyl ether | 162° C. |
| Dipropylene glycol dimethyl ether | 171° C. |
| Diethylene glycol ethyl methyl ether | 176° C. |
| Diethylene glycol isopropyl methyl ether | 179° C. |
| Dipropylene glycol monomethyl ether | 188° C. |
| Diethylene glycol diethyl ether | 189° C. |
| Diethylene glycol monomethyl ether | 194° C. |
| Diethylene glycol butyl methyl ether | 212° C. |
| Tripropylene glycol dimethyl ether | 215° C. |
| Triethylene glycol dimethyl ether | 216° C. |
| Diethylene glycol monobutyl ether | 230° C. |
| 2-Pyrrolidone | 245° C. |
| Propylene glycol | 188° C. |
| Dipropylene glycol | 232° C. |
| Ethylene glycol | 197° C. |
| Diethylene glycol | 244° C. |
| Triethylene glycol monomethyl ether | 249° C. |
| γ-Butyrolactone | 203° C. |
| Dimethyl sulfoxide (DMSO) | 189° C. |

The content of the solvent (the total content in a case of two or more solvents) having a boiling point of 150° C. to 250° C. is preferably in a range of 2% by mass to 50% by mass with respect to the total amount of the aqueous ink.

In a case where the total content thereof is 2% by mass or greater, the jettability from a head and the storage stability are further improved, the solvent is unlikely to remain after the aqueous ink is dried, and the fixing properties of the image are excellent.

The total content of the solvent having a boiling point of 150° C. to 250° C. is more preferably in a range of 3% by mass to 20% by mass and still more preferably in a range of 5% by mass to 18% by mass with respect to the total amount of the aqueous ink.

—Solvent Having Boiling Point of Higher than 250° C.—

The aqueous ink may contain a solvent having a boiling point of higher than 250° C. within the range (1% by mass or less) not significantly damaging the effects. The expression “the content of the solvent having a boiling point of higher than 250° C. is 1% by mass or less with respect to the total mass of the aqueous ink” indicates that the aqueous ink does not substantially contain the solvent having a boiling point of higher than 250° C. Accordingly, the content of the solvent having a boiling point of higher than 250° C. is preferably 0.5% by mass or less, more preferably 0.2% by mass or less, and still more preferably 0% by mass (in other words, the aqueous ink does not contain the solvent).

In a case where the aqueous ink does not substantially contain the solvent having a boiling point of higher than 250° C., the solvent is unlikely to remain in the drying step and an image having excellent fixing properties can be formed.

Examples of the solvent having a boiling point of higher than 250° C. include solvents listed in Table 2.

TABLE 2

| Solvent having boiling point of higher than 250° C. | Boiling point | |
|---|---|---|
| Diethylene glycol dibutyl ether | 256° | C. |
| Triethylene glycol butyl methyl ether | 261° | C. |
| Polyethylene glycol dimethyl ether | 264~294° | C. |
| Tetraethylene glycol dimethyl ether | 275° | C. |
| Polyethylene glycol monomethyl ether | 290~310° | C. |
| Glycerin | 290° | C. |
| Triethylene glycol butyl methyl ether | 287° | C. |
| Sulfolane | 285° | C. |

—Colorant—

The aqueous ink contains at least one colorant.

The colorant contained in the aqueous ink is not particularly limited and can be appropriately selected from pigments and dyes. As the colorant, a pigment is preferable and a resin-coated pigment having a structure in which at least a part of the surface of the pigment is coated with a resin (hereinafter, also referred to as a “coating resin”) is more preferable. In this manner, the dispersion stability of the aqueous ink is improved and the quality of an image to be formed is improved.

——Pigment——

The pigment is not particularly limited and can be appropriately selected depending on the purpose thereof. For example, the pigment may be any of an organic pigment and an inorganic pigment. Further, a carbon black pigment, a magenta pigment, a cyan pigment, or a yellow pigment may be used as a color pigment. From the viewpoint of ink colorability, it is preferable that the pigment is almost insoluble or hardly soluble in water.

Examples of the organic pigment include an azo pigment, a polycyclic pigment, chelate dye, a nitro pigment, a nitroso pigment, and aniline black. Among these, an azo pigment and a polycyclic pigment are preferable.

Examples of the inorganic pigment include titanium oxide, iron oxide, calcium carbonate, barium sulfate, aluminum hydroxide, yellow barium, cadmium red, chrome yellow, and carbon black.

From the viewpoints of color reproducibility, it is preferable that the average particle diameter of the organic pigment is small. However, from the viewpoint of light fastness, it is preferable that the average particle diameter thereof is large. From the viewpoint of balancing these, the average particle diameter thereof is preferably in a range of 10 nm to 200 nm, more preferably in a range of 10 nm to 150 nm, and still more preferably in a range of 10 nm to 120 nm. Further, the particle size distribution of the pigment is not particularly limited, and any of a pigment having a wide particle size distribution and a pigment having a monodispersed particle size distribution may be used. In addition, two or more pigments having a monodispersed particle size distribution may be mixed and then used.

As the average particle diameter, a value of the volume average particle diameter measured by a particle size distribution measuring device (for example, MICROTRAC UPA (registered trademark) EX150, manufactured by NIKKOSO CO., LTD.) that uses light scattering is employed. Further, as the particle size distribution, a value measured by a particle size distribution measuring device (for example, MICROTRAC UPA (registered trademark) EX150, manufactured by NIKKOSO CO., LTD.) that uses light scattering is employed.

The pigment may be used alone or in combination of two or more kind thereof.

From the viewpoint of the image density, the content of the pigment in the aqueous ink is preferably in a range of 1% by mass to 20% by mass and more preferably in a range of 2% by mass to 10% by mass with respect to the total amount of the aqueous ink.

——Coating Resin——

As the coating resin contained in the resin-coated pigment, a dispersant is preferable.

The dispersant may be any of a polymer dispersant and a low-molecular-weight surfactant-type dispersant.

Further, the polymer dispersant may be any of a water-soluble dispersant and a water-insoluble dispersant.

As the low-molecular-weight surfactant-type dispersant, for example, known low-molecular-weight surfactant-type dispersants described in paragraphs 0047 to 0052 of JP2011-178029A can be used.

Among polymer dispersants, hydrophilic polymer compounds are exemplified as the water-soluble dispersant. Examples of natural hydrophilic polymer compounds include vegetable polymers such as Arabic gum, tragacanth gum, guar gum, karaya gum, locust bean gum, arabinogalactone, pectin, and quince seed starch; seaweed-based polymers such as alginic acid, carrageenan, and agar; animal polymers such as gelatin, casein, albumin, and collagen; and microbial polymers such as xanthan gum and dextran.

Further, examples of the hydrophilic polymer compound obtained by modifying a natural product with a raw material include fibrous polymers such as methyl cellulose, ethyl cellulose, hydroxyethyl cellulose, hydroxypropyl cellulose, and carboxymethyl cellulose; starch-based polymers such as sodium starch glycolate and sodium starch phosphoric acid ester; and seaweed-based polymers such as sodium alginate and propylene glycol alginic acid ester.

Further, examples of synthetic hydrophilic polymer compounds include a vinyl-based polymer such as polyvinyl alcohol, polyvinylpyrrolidone, or polyvinyl methyl ether; an acrylic resin such as non-cross-linked polyacrylamide, polyacrylic acid or an alkali metal salt thereof, or a water-soluble styrene acrylic resin; and a natural polymer compound such as a water-soluble styrene maleic acid resin, a water-soluble vinyl naphthalene acrylic resin, a water-soluble vinyl naphthalene maleic acid resin, polyvinylpyrrolidone, polyvinyl alcohol, an alkali metal salt of a β-naphthalenesulfonic acid formalin condensate, a polymer compound having a salt of a cationic functional group such as quaternary ammonium or an amino group in a side chain, or a natural polymer compound such as shellac.

Among these, a water-soluble dispersant into which a carboxy group is introduced, such as a homopolymer of acrylic acid, methacrylic acid, or styrene acrylic acid; or a copolymer with monomers having other hydrophilic groups, is preferable.

Among the polymer dispersants, a polymer having both of a hydrophobic part and a hydrophilic part can be used as a water-insoluble dispersant. As a hydrophilic part, a structural unit having an acidic group is preferable and a structural unit having a carboxy group is more preferable. Examples of the water-insoluble dispersant include a styrene-(meth)acrylic acid copolymer, a styrene-(meth)acrylic acid-(meth)acrylic acid ester copolymer, a (meth)acrylic acid ester-(meth)acrylic acid copolymer, a polyethylene glycol (meth)acrylate-(meth)acrylic acid copolymer, a vinyl acetate-maleic acid copolymer, and a styrene-maleic acid copolymer.

Specific examples thereof include water-insoluble resins described in JP2005-41994A, JP2006-273891A, JP2009-084494A, and JP2009-191134A.

The weight-average molecular weight of the polymer dispersant is preferably in a range of 3000 to 100000, more preferably in a range of 5000 to 50000, still more preferably in a range of 5000 to 40000, and particularly preferably in a range of 10000 to 40000.

Further, the weight-average molecular weight of the polymer dispersant indicates a value acquired by the above-described method.

From the viewpoints of self-dispersibility and the aggregation rate in a case where a treatment liquid comes into contact with the polymer dispersant, it is preferable that the polymer dispersant contains a carboxy group, more preferable that the polymer dispersant contains a carboxy group and having an acid value of 130 mgKOH/g or less, and still more preferable that the polymer dispersant has an acid value of 25 mgKOH/g to 120 mgKOH/g. Particularly, a polymer dispersant containing a carboxy group and having an acid value of 25 mg/KOH/g to 100 mg/KOH/g is effective.

The mixing mass ratio (p:s) of the pigment (p) to the dispersant (s) is preferably in a range of 1:0.06 to 1:3, more preferably in a range of 1:0.125 to 1:2, and still more preferably in a range of 1:0.125 to 1:1.5.

The content of the coating resin used for coating a pigment is preferably in a range of 0.5% by mass to 3.0% by mass, more preferably in a range of 1.0% by mass to 2.8% by mass, and still more preferably in a range of 1.2% by mass to 2.5% by mass with respect to the total mass of the aqueous ink

The volume average particle diameter (secondary particle diameter) of the resin-coated pigment (pigment in a dispersed state) is preferably in a range of 10 nm to 200 nm, more preferably in a range of 10 nm to 150 nm, and still more preferably in a range of 10 nm to 100 nm. In a case where the volume average particle diameter thereof is 200 nm or less, the color reproducibility becomes excellent and the jettability at the time of jetting the ink according to the ink jet method becomes excellent. In a case where the volume average particle diameter thereof is 10 nm or greater, the light fastness becomes excellent.

In addition, the particle size distribution of the colorant is not particularly limited and may be any of a wide particle size distribution and a monodispersed particle size distribution. Further, the colorant having a monodispersed particle size distribution may be used in a combination of two or more kinds thereof. Here, the volume average particle diameter of the pigment in a dispersed state indicates an average particle diameter in a state in which the ink is obtained, and the same applies to a so-called concentrated ink dispersion at a stage before the ink is obtained.

Here, the volume average particle diameter of the resin-coated pigment indicates a value acquired by the above-described method.

Further, it is preferable that the resin used for coating the pigment in the resin-coated pigment is cross-linked by a cross-linking agent.

In other words, it is preferable that the resin-coated pigment is a resin-coated pigment in which at least a part of the surface of the pigment is coated with the resin that is cross-linked by a cross-linking agent.

In regard to the resin-coated pigment in which at least a part of the surface of the pigment is coated with the resin that is cross-linked by a cross-linking agent, description in paragraphs 0029 to 0048, 0110 to 0118, and 0121 to 0129 of JP2012-162655A and paragraphs 0035 to 0071 of JP2013-47311A can be referred to.

The cross-linking agent is not particularly limited as long as the cross-linking agent is a compound having two or more sites reacting with a resin. Among examples of such a compound, from the viewpoint of excellent reactivity with a carboxy group, a compound (bi- or higher functional epoxy compound) having two or more epoxy groups is preferable.

Specific examples of the cross-linking agent include ethylene glycol diglycidyl ether, polyethylene glycol diglycidyl ether, 1,6-hexanediol diglycidyl ether, diethylene glycol diglycidyl ether, dipropylene glycol diglycidyl ether, polypropylene glycol diglycidyl ether, and trimethylolpropane triglycidyl ether. Among these, polyethylene glycol diglycidyl ether, diethylene glycol diglycidyl ether, and trimethylolpropane triglycidyl ether are preferable.

Commercially available products can be used as the cross-linking agent. Examples of the commercially available products include Denacol (registered trademark) EX-321, EX-821, EX-830, EX-850, and EX-851 (manufactured by ChemteX Corporation).

From the viewpoints of the cross-linking reaction rate and dispersion stability of the resin-coated pigment after the cross-linking, the molar ratio between a cross-linking site (for example, an epoxy group) of the cross-linking agent and a cross-linked site of a resin (for example, a carboxy group) is preferably in a range of 1:1 to 1:10, more preferably in a range of 1:1 to 1:5, and most preferably in a range of 1:1 to 1:1.5.

—Resin Particles—

The aqueous ink contains at least one kind of resin particles. In this manner, an image is fixed onto the transparent resin base material, and the rub resistance of the image is further improved.

In a case where the resin particles are brought into contact with the treatment liquid or a region where the treatment liquid has been dried, the resin particles have a function of immobilizing the aqueous ink by dispersion thereof being destabilized in the aqueous ink, being aggregated, and then being thickened. In this manner, the rub resistance of the image is further improved. Further, the adhesiveness of the aqueous ink to the transparent resin base material is also further improved.

As the resin particles, for example, resin particles formed of a resin selected from thermoplastic resins and thermosetting resins can be used.

These resins may be modified resins.

Examples of the resin used for forming resin particles include an acrylic resin, an epoxy resin, a urethane resin, polyether, polyamide, unsaturated polyester, polyolefin, a phenol resin, a silicone resin, a fluorine resin, polyvinyl (such as vinyl chloride, vinyl acetate, polyvinyl alcohol, or polyvinyl butyral), an alkyd resin, a polyester resin (such as a phthalic acid resin), and an amino resin (such as a melamine resin, a melamine formaldehyde resin, an amino alkyd co-condensation resin, or a urea resin).

The resin forming resin particles may be a copolymer having two or more structural units forming resins exemplified above or a mixture of two or more resins. As the resin particles, not only particles formed of a mixture of two or more resins but also composite resin particles formed by two or more resins being laminated as in a case of a core and shell may be exemplified.

The resin particles may be used alone or in combination of two or more kinds thereof.

As the resin particles, particles of an acrylic resin, a urethane resin, polyether, polyester, or polyolefin are preferable. From the viewpoints of stability and the quality of the formed film (image), particles of an acrylic resin or particles of a urethane resin are more preferable.

The aqueous ink may contain resin particles in the form of an aqueous dispersion containing the resin particles, that is, so-called latex.

In the present specification, an acrylic resin indicates a resin having a structural unit derived from (meth)acrylic acid. An acrylic resin may have a structural unit other than the structural unit derived from (meth)acrylic acid.

The glass transition temperature (Tg) of the resin particles is preferably 40° C. or higher.

The upper limit of the glass transition temperature of the resin particles is preferably 250° C.

The glass transition temperature of the resin particles is preferably in a range of 50° C. to 230° C.

The glass transition temperature of resin particles is appropriately controlled by a method which has been typically used. For example, the glass transition temperature of resin particles can be controlled to be in a desired range by appropriately selecting the type of monomer (polymerizable compound) forming the resin particles, the configuration ratio thereof, and the molecular weight of a polymer forming the resin particles.

As the glass transition temperature, a value measured according to the above-described method is employed.

As the resin particles, resin particles obtained by a phase-transfer emulsification method are preferable and particles of a self-dispersing polymer (self-dispersing polymer particles) are more preferable.

Here, the self-dispersing polymer indicates a water-insoluble polymer which may enter a dispersed state in an aqueous medium by a functional group (particularly, an acidic group of a carboxy group or the like or a salt thereof) contained in the polymer itself in a case where the polymer has entered the dispersed state according to the phase-transfer emulsification method in the absence of a surfactant.

Here, the concept of the dispersed state includes both of an emulsified state (emulsion) in which a water-insoluble polymer is dispersed in the aqueous medium in a liquid state and a dispersed state (suspension) in which a water-insoluble polymer is dispersed in the aqueous medium in a solid state.

In addition, the term “water-insoluble” means that the amount of substance to be dissolved in 100 parts by mass (25° C.) of water is less than 5.0 parts by mass.

As the phase-transfer emulsification method, a method of dissolving or dispersing a polymer in a vehicle (for example, a water-soluble solvent), putting the solution into water without adding a surfactant thereto, stirring and mixing the solution, and removing the vehicle in a state in which a salt-forming group (for example, an acidic group) contained in the polymer is neutralized to obtain an aqueous dispersion in an emulsified or dispersed state may be exemplified.

The self-dispersing polymer particles can be selected from among self-dispersing polymer particles described in paragraphs 0090 to 0121 of JP2010-64480A and paragraphs 0130 to 0167 of JP2011-068085A and then used. Particularly, it is preferable that particles having a glass transition temperature of 100° C. or higher are selected from among self-dispersing polymer particles described in the same publications and then used

As described above, self-dispersing polymer particles containing a carboxy group are preferable as the self-dispersing polymer particles.

A polymer having a structural unit derived from unsaturated carboxylic acid (preferably (meth)acrylic acid) is more preferable as the self-dispersing polymer particles containing a carboxy group.

The form of particles formed of a polymer which has a structural unit having an alicyclic group, a structural unit having an alkyl group, and a structural unit derived from unsaturated carboxylic acid (preferably (meth)acrylic acid) is a still more preferable form of the self-dispersing polymer particles containing a carboxy group.

The content (total content in a case where two or more structural units are included in the polymer) of the structural unit having an alicyclic group in the polymer is preferably in a range of 3% by mass to 95% by mass, more preferably in a range of 5% by mass to 75% by mass, and still more preferably in a range of 10% by mass to 50% by mass with respect to the total amount of the polymer.

The content (total content in a case where two or more structural units are included in the polymer) of the structural unit having an alkyl group in the polymer is preferably in a range of 5% by mass to 90% by mass, more preferably in a range of 10% by mass to 85% by mass, still more preferably in a range of 20% by mass to 80% by mass, even still more preferably in a range of 30% by mass to 75% by mass, and even still more preferably in a range of 40% by mass to 75% by mass with respect to the total amount of the polymer.

The content (total content in a case where two or more structural units are included in the polymer) of the structural unit derived from an unsaturated carboxylic acid (preferably (meth)acrylic acid) in the polymer is preferably in a range of 2% by mass to 30% by mass, more preferably in a range of 5% by mass to 20% by mass, and still more preferably in a range of 5% by mass to 15% by mass with respect to the total amount of the polymer.

Further, a polymer in which the structural unit having an alicyclic group is changed into a structural unit having an aromatic group or a polymer which has a structural unit having an aromatic group in addition to the structural unit having an alicyclic group, in the “still more preferable form of the self-dispersing polymer particles containing a carboxy group” described above, is also preferable as the form of self-dispersing polymer particles containing a carboxy group.

In both polymer, the total content of the structural unit having an alicyclic group and a structural unit having an aromatic group is preferably in a range of 3% by mass to 95% by mass, more preferably in a range of 5% by mass to 75% by mass, and still more preferably in a range of 10% by mass to 50% by mass with respect to the total amount of the polymer.

It is preferable that the structural unit having an alicyclic group is a structural unit derived from alicyclic (meth)acrylate.

Examples of the alicyclic (meth)acrylate include monocyclic (meth)acrylate, bicyclic (meth)acrylate, and tri cyclic (meth)acrylate.

Examples of the monocyclic (meth)acrylate include cycloalkyl (meth)acrylate in which the number of carbon atoms in a cycloalkyl group is in a range of 3 to 10, such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate, or cyclodecyl (meth)acrylate.

Examples of the bicyclic (meth)acrylate include isobornyl (meth)acrylate and isobornyl (meth)acrylate.

Examples of the tricyclic (meth)acrylate include adamantly (meth)acrylate, dicyclopentanyl (meth)acrylate, and dicyclopentenyloxyethyl (meth)acrylate.

The alicyclic (meth)acrylate may be used alone or in combination of two or more kinds thereof.

Among the examples of the alicyclic (meth)acrylate, from the viewpoints of fixing properties, blocking resistance, and dispersion stability of self-dispersing polymer particles, bicyclic (meth)acrylate or tri- or higher cyclic polycyclic (meth)acrylate is preferable; and isobornyl (meth)acrylate, adamantly (meth)acrylate, or dicyclopentenyl (meth)acrylate is more preferable.

As the structural unit having an aromatic group, a structural unit derived from an aromatic group-containing monomer is preferable.

Examples of the aromatic group-containing monomer include an aromatic group-containing (meth)acrylate monomer (such as phenoxyethyl (meth)acrylate, benzyl (meth)acrylate, or phenyl (meth)acrylate) and a styrene-based monomer.

Among these, from the viewpoints of balancing between the hydrophilicity and the hydrophobicity of the polymer chain and ink fixing properties, an aromatic group-containing (meth)acrylate monomer is preferable; phenoxyethyl (meth)acrylate, benzyl (meth)acrylate, or phenyl (meth)acrylate is more preferable; and phenoxyethyl (meth)acrylate or benzyl (meth)acrylate is still more preferable.

As the structural unit having an alkyl group, a structural unit derived from an alkyl group-containing monomer is preferable.

Examples of the alkyl group-containing monomer include alkyl (meth)acrylate such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate, or ethylhexyl (meth)acrylate; an ethylenically unsaturated monomer containing a hydroxyl group such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate, or hydroxyhexyl (meth)acrylate; di alkylaminoalkyl (meth)acrylate such as dimethylamonoethyl (meth)acrylate; and (meth)acrylamide, for example, N-hydroxyalkyl (meth)acrylamide such as N-hydroxymethyl (meth)acrylamide, N-hydroxyethyl (meth)acrylamide, or N-hydroxybutyl (meth)acrylamide, and N-alkoxyalkyl (meth)acrylamide such as N-methoxymethyl (meth)acrylamide, N-ethoxymethyl (meth)acrylamide, N-(n-,iso)butoxymethyl (meth)acryl amide, N-methoxyethyl (meth)acrylamide, N-ethoxyethyl (meth)acrylamide, or N-(n,iso)butoxyethyl (meth)acrylamide.

Among these, alkyl (meth)acrylate is preferable; alkyl (meth)acrylate in which the number of carbon atoms in an alkyl group is in a range of 1 to 4 is more preferable; methyl (meth)acrylate, ethyl (meth)acrylate, isopropyl (meth)acrylate, or butyl (meth)acrylate is still more preferable; and methyl (meth)acrylate is even still more preferable.

Hereinafter, exemplary compounds P-1 to P-5 will be described as specific examples of the self-dispersing polymer particles, but the self-dispersing polymer particles are not limited to these examples. Further, the numerical values in the parenthesis indicate the mass ratios of the copolymer components.
P-1: methyl methacrylate/isobornyl methacrylate/methacrylic acid copolymer (70/20/10)
P-2: methyl methacrylate/isobornyl methacrylate/methacrylic acid copolymer (48/42/10)
P-3: methyl methacrylate/benzyl methacrylate/methacrylic acid copolymer (65/25/10)
P-4: isopropyl methacrylate/isobornyl methacrylate/methacrylic acid copolymer (50/40/10)
P-5: butyl methacrylate/dicyclopentanyl methacrylate/methacrylic acid copolymer (60/30/10)

Further, as described above, particles of a urethane resin are also preferable as the resin particles.

As the urethane resin, a urethane resin obtained by reacting a diol compound and a diisocyanate compound is exemplified.

In regard to the details of the diol compound and the diisocyanate compound, the description in paragraphs 0031 to 0036 of JP2001-247787A can be referred to. Among the examples, a polyester-based urethane resin or a polyether-based urethane resin which has an ester bond in a main chain structure is preferably used.

In regard to the urethane resin, the description in paragraphs 0128 to 0136 of JP2013-227498A can be referred to as appropriate.

The weight-average molecular weight of the polymer forming resin particles (preferably self-dispersing polymer particles, the same applies hereinafter) is preferably in a range of 3000 to 200000, more preferably in a range of 5000 to 150000, and still more preferably in a range of 10000 to 100000.

In a case where the weight-average molecular weight is 3000 or greater, the amount of water-soluble components can be effectively suppressed. Further, the self-dispersion stability can be improved by setting the weight-average molecular weight to 200000 or less.

As the weight-average molecular weight, a value measured by the above-described gel permeation chromatography (GPC) is employed.

From the viewpoints of self-dispersibility and the aggregation rate in a case where the polymer forming resin particles is brought into contact with a treatment liquid, the acid value of the polymer is preferably 100 mgKOH/g or less and more preferably in a range of 25 mgKOH/g to 100 mgKOH/g.

The volume average particle diameter of the resin particles is preferably in a range of 1 nm to 200 nm, more preferably in a range of 1 nm to 150 nm, still more preferably in a range of 1 nm to 100 nm, and particularly preferably in a range of 1 nm to 10 nm. In a case where the volume average particle diameter thereof is 1 nm or greater, the manufacturing suitability is improved. Further, in a case where the volume average particle diameter is 200 nm or less, the storage stability is improved. Further, the particle size distribution of resin particles is not particularly limited, and the resin particles may be a wide particle size distribution or a monodispersed particle size distribution. Two or more kinds of resin particles may be mixed and then used.

As the volume average particle diameter, a value measured according to the above-described method is employed.

The content (total content in a case where two or more kinds of resin particles are contained in the aqueous ink) of the resin particles (preferably self-dispersing polymer particles) in the aqueous ink is not particularly limited, but is preferably in a range of 0.3% by mass to 15.0% by mass, more preferably in a range of 4.0% by mass to 12.0% by mass, and still more preferably in a range of 7.0% by mass to 9.0% by mass with respect to the total amount of the aqueous ink.

In a case where the content of the resin particles in the aqueous ink is 0.3% by mass or greater, the rub resistance of an image is further improved and the image irregularity can be further suppressed.

It is advantageous that the content of the resin particles in the aqueous ink is 15.0% by mass or less from the viewpoint that the jettability of the ink can be further improved and generation of precipitates in a low temperature environment is suppressed.

—Water—

The aqueous ink contains water. The content of water contained in the aqueous ink is not particularly limited, but the content of water can be set to 50% by mass or greater with respect to the total amount of the aqueous ink.

The content of water contained in the aqueous ink is preferably in a range of 50% by mass to 80% by mass, more preferably in a range of 50% by mass to 75% by mass, and still more preferably in a range of 50% to 70% by mass with respect to the total amount of the aqueous ink.

—Surfactant—

The aqueous ink may contain at least one surfactant as necessary. The surfactant can be used as a surface tension adjuster.

As the surfactant, a compound having a structure that has both of a hydrophilic part and a hydrophobic part in a molecule can be effectively used, and any of an anionic surfactant, a cationic surfactant, an amphoteric surfactant, a non-ionic surfactant, or a betaine-based surfactant can be used. Further, the above-described polymer dispersant may be used as a surfactant.

From the viewpoint of suppressing jetting interference of the aqueous ink, a non-ionic surfactant is preferable as the surfactant. Among the examples of the non-ionic surfactant, an acetylene glycol derivative (acetylene glycol-based surfactant) is more preferable.

Examples of the acetylene glycol-based surfactant include 2,4,7,9-tetramethyl-5-decyne-4,7-diol and an alkylene oxide adduct of 2,4,7,9-tetramethyl-5-decyne-4,7-diol. It is preferable that the acetylene glycol-based surfactant is at least one selected from these. Examples of commercially available products of these compounds include E series of OLFINE E1010 (manufactured by Nissin Chemical Industry Co., Ltd.).

A fluorine-based surfactant is preferable as a surfactant other than the acetylene glycol-based surfactant. Examples of the fluorine-based surfactant include an anionic surfactant, a non-ionic surfactant, and a betaine-based surfactant. Among these, an anionic surfactant is more preferable. Examples of the anionic surfactant include CAPSTONE FS-63, CAPSTONE FS-61 (manufactured by Dupont), FTERGENT 100, FTERGENT 110, FTERGENT 150 (all manufactured by NEOS COMPANY LIMITED), and CHEMGUARD S-760P (manufactured by Chemguard Inc.).

In a case where the aqueous ink contains a surfactant (surface tension adjuster), from the viewpoint of satisfactorily jetting the aqueous ink according to the ink jet system, the amount of the surfactant to be contained in the aqueous ink is set such that the surface tension of the aqueous ink can be adjusted to be preferably in a range of 20 mN/m to 60 mN/m, more preferably in a range of 20 mN/m to 45 mN/m from the viewpoint of the surface tension, and still more preferably in a range of 25 mN/m to 40 mN/m.

Here, the surface tension of the aqueous ink indicates a value measured in a liquid temperature condition of 25° C. using an Automatic Surface Tensiometer CBVP-Z (manufactured by Kyowa Interface Science Co., Ltd.).

In a case where the aqueous ink contains a surfactant, the specific amount of the surfactant is not particularly limited, but is preferably 0.1% by mass or greater, more preferably in a range of 0.1% by mass to 10% by mass, and still more preferably in a range of 0.2% by mass to 3% by mass with respect to the total amount of the aqueous ink.

—Colloidal Silica—

The aqueous ink may contain colloidal silica as necessary.

In this manner, the stability during continuous jetting of the ink can be further improved.

The colloidal silica is a colloid formed of particles of an inorganic oxide that contains silicon having an average particle diameter of several hundreds of nanometers or less. The colloidal silica contains silicon dioxide (including the hydrate thereof) as a main component and may contain aluminate (such as sodium aluminate or potassium aluminate) as a small amount of component.

Further, the colloidal silica may contain inorganic salts such as sodium hydroxide, potassium hydroxide, lithium hydroxide, and ammonium hydroxide; and organic salts such as tetramethylammonium hydroxide. These inorganic salts and the organic salts act, for example, as a colloidal stabilizer.

In regard to the colloidal silica, for example, the description in paragraphs 0043 to 0050 of JP2011-202117A can be referred to.

Further, the aqueous ink may contain alkali silicate metal salts in place of or in addition to colloidal silica as necessary. In regard to the alkali silicate metal salts, the description in paragraphs 0052 to 0056 of JP2011-202117A can be referred to.

Further, commercially available products may be used and examples thereof include SNOWTEX (registered trademark) XS (manufactured by Nissan Chemical Industries, Ltd., colloidal silica).

In a case where the aqueous ink used in the embodiment of the present invention contains colloidal silica, the content of colloidal silica is preferably in a range of 0.0001% by mass to 10% by mass, more preferably in a range of 0.01% by mass to 3% by mass, still more preferably in a range of 0.02% by mass to 0.5% by mass, and particularly preferably in a range of 0.03% by mass to 0.3% by mass with respect to the total amount of the aqueous ink.

—Urea—

The aqueous ink may contain urea.

Since urea has an excellent moisturizing function, urea is capable of effectively suppressing undesired drying or solidification of the ink as a solid wetting agent.

In a case where the aqueous ink contains the colloidal silica and urea, the maintainability (wiping workability) of an ink jet head or the like is more effectively improved.

From the viewpoint of improving maintainability (wiping workability), the content of urea in the aqueous ink used in the embodiment of the present invention is preferably in a range of 1% by mass to 20% by mass, more preferably in a range of 1% by mass to 15% by mass, and still more preferably in a range of 3% by mass to 10% by mass.

In a case where the aqueous ink contains urea and colloidal silica, the ratio between the content of urea and the content of colloidal silica is not particularly limited, but the ratio (urea/colloidal silica) of the content of urea to the content of colloidal silica is preferably in a range of 5 to 1000, more preferably in a range of 10 to 500, and still more preferably in a range of 20 to 200.

In the case where the aqueous ink used in the embodiment of the present invention contains urea and colloidal silica, a combination of the content of urea and the content of colloidal silica is not particularly limited, but the following combination is preferable from the viewpoint of more effectively balancing the wiping properties and the fixing properties of an image.

That is, a combination of urea at a content of 1.0% by mass or greater and colloidal silica at a content of 0.01% by mass or greater is preferable; a combination of urea at a content of 1.0% by mass to 20% by mass and colloidal silica at a content of 0.02% by mass to 0.5% by mass is more preferable; and a combination of urea at a content of 3.0% by mass to 10% by mass and colloidal silica at a content of 0.03% by mass 0.3% by mass is particularly preferable.

—Water-Soluble Polymer Compound—

The aqueous ink contains at least one water-soluble polymer compound as necessary.

The water-soluble polymer compound is not particularly limited, and known water-soluble polymer compounds such as polyvinyl alcohol, polyacrylamide, polyvinylpyrrolidone, and polyethylene glycol can be used.

Further, as the water-soluble polymer compounds, specific polymer compounds which can be contained in the treatment liquid described above and water-soluble polymer compounds described in paragraphs 0026 to 0080 of JP2013-001854A are suitable.

Further, commercially available products may be used and examples thereof include PVP K-15 (manufactured by ISB CORPORATION).

In a case where the aqueous ink used in the embodiment of the present invention contains a water-soluble polymer compound, the content of the water-soluble polymer compound is preferably in a range of 0.0001% by mass to 10 by mass, more preferably in a range of 0.01% by mass to 3% by mass, still more preferably in a range of 0.02% by mass to 0.5% by mass, and particularly preferably in a range of 0.03% by mass to 0.3% by mass with respect to the total amount of the aqueous ink.

—Anti-Foaming Agent—

The aqueous ink may contain at least one anti-foaming agent as necessary.

Examples of the anti-foaming agent include a silicone-based compound (a silicone-based anti-foaming agent) and a pluronic compound (pluronic anti-foaming agent). Among these, a silicone-based anti-foaming agent is preferable.

As the silicone-based anti-foaming agent, a silicone-based anti-foaming agent having a polysiloxane structure is preferable.

As the anti-foaming agent, commercially available products can be used.

Examples of the commercially available products include BYK (registered trademark)-012, 017, 021, 022, 024, 025, 038, and 094 (all manufactured by manufactured by Big Chemie Japan Co., Ltd.); KS-537, KS-604, KM-72F (all manufactured by Shin-Etsu Chemical Co. Ltd.); TSA-739 (manufactured by Momentive Performance Material Inc.), and Olefin (registered trademark) AF104 (manufactured by Nissin Chemical Co., Ltd.).

Among these, BYK-017, 021, 022, 024, 025, 094, KS-537, KS-604, KM-72F, and TSA-739 serving as a silicone-based anti-foaming agent are preferable. Among these, from the viewpoint of jetting stability of an ink, BYK-024 is most preferable.

In a case where the aqueous ink contains an anti-foaming agent, the content of the anti-foaming agent is preferably in a range of 0.0001% by mass to 1% by mass and more preferably in a range of 0.001% by mass to 0.1% by mass with respect to the total amount of the aqueous ink.

—Inorganic Salt—

The aqueous ink may contain at least one kind of inorganic salt as necessary. In this manner, the surface roughening of the formed image is suppressed.

Here, the surface roughening indicates a phenomenon in which portions where the concentration of the aqueous ink is high and portions where the concentration thereof is low are unevenly distributed in an intermediate region (halftone region) between a bright region (highlight) and a dark region (shadow) of an image so that the surface thereof appears to be rough.

The “surface roughening” is not a phenomenon occurring due to local insufficient aggregation of aqueous ink, such as “blurring” or “streak” of the related art, but a phenomenon occurring due to non-uniform aggregation caused by non-uniform distribution of a treatment liquid on a transparent resin base material.

As the inorganic salt, a hydrochloride or a nitrate is preferable.

Among these, from the viewpoints of markedly suppressing a decrease in thickening of the aqueous ink and suppressing the surface roughening, a monovalent salt is preferable; an alkali metal salt is more preferable; and lithium chloride, lithium nitrate, potassium chloride, or potassium nitrate is still more preferable.

The inorganic salt may be used alone or in combination of two or more kinds thereof.

In a case where the aqueous ink used in the embodiment of the present invention contains an inorganic salt, the content (total content in a case where two or more kinds of inorganic salts are contained in the aqueous ink) of the inorganic salt in the aqueous ink is not particularly limited, but is preferably in a range of 0.001% by mass to 0.2% by mass, more preferably in a range of 0.005% by mass to 0.1% by mass, and still more preferably in a range of 0.01% by mass to 0.05% by mass.

In a case where the aqueous ink contains the coating resin and the inorganic salt described above, from the viewpoints of suppressing reduction of the viscosity of the aqueous ink and suppressing surface roughening an image, the mass ratio (coating resin:inorganic salt) of the coating resin to an inorganic salt described below is preferably in a range of 10 to 250, more preferably in a range of 15 to 200, and still more preferably in a range of 30 to 150.

—Wax Particles—

The aqueous ink may contain at least one kind of wax particles. In this manner, the rub resistance can be further improved.

Examples of wax particles include a plant-based wax such as carnauba wax, candelilla wax, beeswax, rice wax, or lanolin, an animal wax, a petroleum-based wax such as paraffin wax, microcrystalline wax, polyethylene wax, polyethylene oxide wax, or petrolatum, a mineral wax such as montan wax or ozokerite, a synthetic wax such as carbon wax, hoechst wax, polyolefin wax, or stearic acid amide, a natural wax such as an α-olefin-maleic anhydride copolymer, particles of a synthetic wax, and mixed particles of these.

It is preferable that the wax particles are added in the form of a dispersion. For example, the aqueous ink contains the wax as a dispersion such as an emulsion. It is preferable that the vehicle in a case where the wax is contained in the aqueous ink as a dispersion is water, but the vehicle is not limited thereto. For example, the vehicle may be appropriately selected from organic vehicles which have been typically used and can be used during the dispersion. In regard to the organic vehicles, the description of paragraph 0027 of JP2006-91780A can be referred to.

The wax particles may be used alone or in combination of plural kinds thereof.

As the wax particles, commercially available products may be used. Examples of the commercially available products include NOPCOAT PEM17 (manufactured by SAN NOPCO LIMITED), CHEMIPEARL (registered trademark) W4005 (manufactured by Mitsui Chemicals, Inc.), AQUACER 515 and AQUACER 593 (both manufactured by Big Chemie Japan Co., Ltd.), and SELOSOL 524 (manufactured by CHUKYO YUSHI CO., LTD.).

Among these, carnauba wax or polyolefin wax is preferable as the wax, and carnauba wax is particularly preferable from the viewpoint of rub resistance.

In a case where the aqueous ink used in the present invention contains wax particles, the ratio of the content of resin particles to the content of wax particles (resin particles:wax particles) is preferably in a range of 1:5 to 5:1 (ratio between solid contents). In a case where the ratio of the content of resin particles to the content of wax particles is in the above-described range, an image having excellent rub resistance can be formed.

—Other Components—

The aqueous ink may contain other components in addition to the above-described components as necessary.

Examples of other components include known additives such as a solid wetting agent, a fading inhibitor, an emulsion stabilizer, a penetration enhancer, an ultraviolet absorbing agent, a preservative, an antibacterial agent, a pH adjuster, a viscosity adjuster, a rust inhibitor, and a chelating agent.

The aqueous ink used in the embodiment of the present invention may be active energy ray (for example, ultraviolet ray) curable aqueous ink that contains at least one polymerizable compound.

In this case, it is preferable that the aqueous ink (at least one of the aqueous ink or the treatment liquid in a case where the treatment liquid described below is used) further contains a polymerization initiator.

Examples of the polymerizable compound include polymerizable compounds (for example, a bi- or higher functional (meth)acrylamide compound) described in paragraphs 0128 to 0144 of JP2011-184628A, paragraphs 0019 to 0034 of JP2011-178896A, and paragraphs 0065 to 0086 of JP2015-25076A.

Examples of the polymerization initiator include known polymerization initiators described in paragraphs 0186 to 0190 of JP2011-184628A, paragraphs 0126 to 0130 of JP2011-178896A, and paragraphs 0041 to 0064 of JP2015-25076A.

˜Ink Jet System˜

Next, a method of forming an image using the transparent resin base material, the aqueous ink, and the treatment liquid described above according to the ink jet system will be described in detail.

The ink jet system used in the embodiment of the present invention is not particularly limited, and any of known methods such as an electric charge control method of jetting an ink using electrostatic attraction force; a drop-on-demand method (pressure pulse method) using a vibration pressure of a piezoelectric element; an acoustic ink jet system of jetting an ink using a radiation pressure by changing an electric signal into an acoustic beam and radiating the acoustic beam to the ink; and a thermal ink jet (bubble jet (registered trademark)) method of heating an ink to form bubbles and utilizing the generated pressure may be used. As an ink jet method, particularly, an ink jet method, described in JP1979-59936A (JP-S54-59936A), of jetting an ink from a nozzle using an action force caused by a rapid change in volume of the ink after being subjected to an action of thermal energy can be effectively used.

A short serial head is used as the ink jet head, and there are two systems for the ink jet head, which are a shuttle system of performing recording while scanning a head in the width direction of the transparent resin base material and a single pass system (line system) of using a line head in which recording elements are disposed corresponding to the entire area of one side of the transparent resin base material. In the single pass system, image recording can be performed on the entire surface of the transparent resin base material by scanning the transparent resin base material in a direction intersecting the direction in which the recording elements are disposed. Therefore, a transport system such as a carriage that scans a short head becomes unnecessary. Further, since movement of a carriage and complicated scanning control between the head and the transparent resin base material become unnecessary and only the transparent resin base material moves, the recording can be performed at a higher speed compared to the shuttle system. The method of forming a parallax picture using the ink jet system according to the present invention can be applied to any of these, but it is preferable that the method is applied to the single pass system that does not perform a dummy jet since the jetting accuracy and the rub resistance of an image are highly improved and drawing can be performed at a high speed.

From the viewpoint of forming a parallax picture with high accuracy, the amount of liquid droplets of ink jetted from the ink jet heads is preferably in a range of 1 pl (pico liter) to 10 pl and more preferably in a range of 1.5 pl to 6 pl from the viewpoint of obtaining an image with high accuracy. From the viewpoints of improving the image irregularity and improving connection of continuous gradations, it is also advantageous that the ink is jetted by combining a different amount of liquid droplets, and the embodiment of the present invention can be suitably used even in this case.

Further, from the viewpoint of forming a high-resolution parallax picture, it is preferable that the aqueous ink is jetted at a resolution of 1200 dpi or greater.

Particularly, it is preferable to use an ink jet recording device which is capable of applying the aqueous ink under conditions of a resolution of 1200 dpi or greater and a minimum liquid droplet size of 3 pl or less. From the viewpoint of productivity, it is preferable to use an ink jet recording device which is capable of forming an image according to a single pass system.

As the ink jet recording device having the above-described performance, Jet Press (registered trademark) 720 (manufactured by Fujifilm Corporation) can be suitably used.

(Drying Step)

The method of producing a transparent resin base printed material of the present disclosure includes a drying step of drying the aqueous ink under a condition in which the surface temperature of the transparent resin base material is in a range of 60° C. to 100° C.

By drying the aqueous ink under a condition in which the surface temperature of the base material in the drying step is 60° C. or higher, the solvent in the aqueous ink is unlikely to remain after the aqueous ink is dried and the fixing properties of an image become excellent.

By drying the aqueous ink under a condition in which the surface temperature of the base material in the drying step is 100° C. or less, the thermal deformation of the transparent resin base printed material can be suppressed.

The surface temperature can be measured using a handy radiation thermometer IT-540N (manufactured by HORIBA, Ltd.).

˜Drying Method˜

It is preferable that the aqueous ink is heated and dried in the present step.

Examples of the means for performing heating and drying include known heating means using a heater or the like, known blast means using a dryer or the like, and means that combining these means.

Examples of the method for performing heating and drying include a method of applying heat using a heater or the like from a side of the transparent resin base material opposite to a surface on which an image is formed; a method of applying warm or hot air to a surface of the transparent resin base material on which an image is formed; a method of applying heat using an infrared heater from a surface of the transparent resin base material on which an image is formed or from a side of the transparent resin base material opposite to a surface on which an image is formed; and a method of combining a plurality of these methods.

The heating temperature of heating and drying an image is a temperature to be set such that the surface temperature of the base material is in a range of 60° C. to 100° C. and preferably in a range of 60° C. to 80° C.

The time for heating and drying the image is not particularly limited, but is preferably in a range of 1 second to 60 seconds, more preferably in a range of 1 second to 30 seconds, and particularly preferably in a range of 1 second to 20 seconds.

˜Ink Jet Recording Device˜

Here, an example of an ink jet recording device which can be used to form an image will be described.

(Overall Configuration of Ink Jet Recording Device)

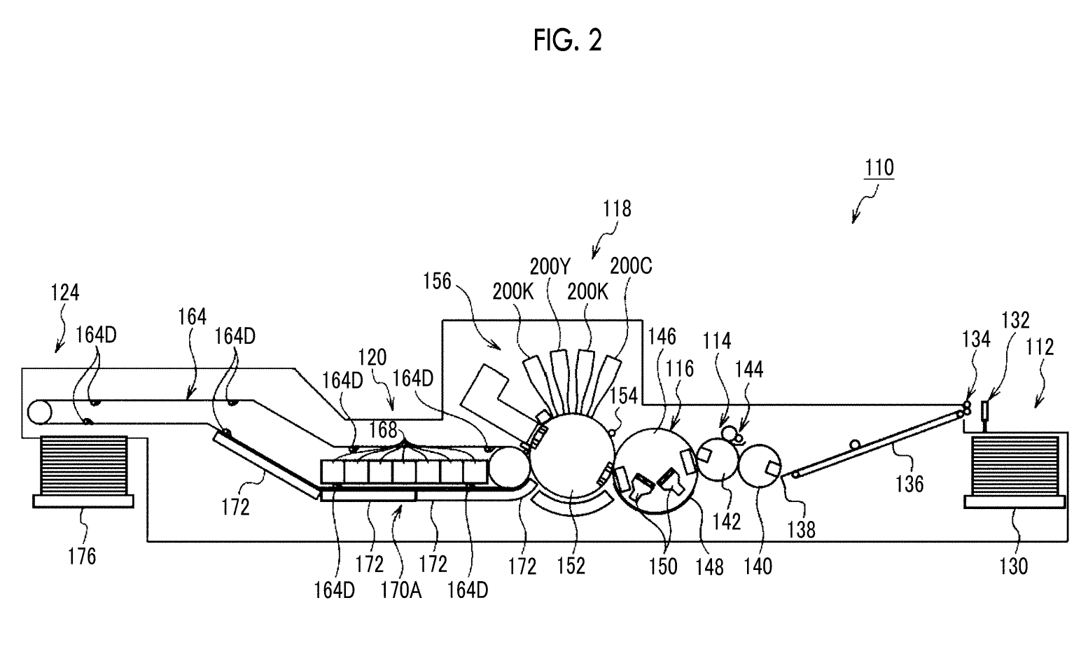

First, the overall configuration of the ink jet recording device will be described. FIG. 2 is an overall configuration view schematically illustrating the overall configuration of the ink jet recording device.

An ink jet recording device 110 records images by jetting four colors of inks, which are, a cyan (C) ink, a magenta (M) ink, a yellow (Y) ink, and a black (K) ink, to a recording medium.

The above-described transparent resin base material is used as the recording medium. Further, the above-described aqueous ink is used as the ink.

As illustrated in FIG. 2, the ink jet recording device 110 mainly includes a supply unit 112 which supplies the transparent resin base material; a treatment liquid coating unit 114 which coats a surface of the transparent resin base material (the ink receiving layer in a case where the ink receiving layer is provided) supplied from the supply unit 112 with a treatment liquid; a treatment liquid drying treatment unit 116 which performs a drying treatment on the transparent resin base material coated with the treatment liquid; an image recording unit 118 which draws an image by jetting an aqueous ink onto the surface of transparent resin base material, which has been subjected to the drying treatment, according to the ink jet system; an aqueous ink drying treatment unit 120 which performs the drying treatment on the transparent resin base material on which the image has been recorded; and a discharge unit 124 which discharges and recovers the transparent resin base material.

—Supply Unit—

The supply unit 112 supplies the transparent resin base material stacked on a supply stand 130 one by one to the treatment liquid coating unit 114. The supply unit 112 mainly includes the supply stand 130, a sucker device 132, a pair of supply rollers 134, a feeder board 136, a front contact 138, and a supply drum 140.

—Treatment Liquid Coating Unit—

The treatment liquid coating unit 114 coats the surface of the transparent resin base material (the ink receiving layer in the case where the ink receiving layer is provided) with the treatment liquid having a function of aggregating the components contained in the aqueous ink. The treatment liquid coating unit 114 mainly includes a treatment liquid coating drum 142 which transports the transparent resin base material; and a treatment liquid coating device 144 which coats the surface of the transparent resin base material (the ink receiving layer in the case where the ink receiving layer is provided) to be transported by the treatment liquid coating drum 142 with the treatment liquid.

The treatment liquid coating device 144 functions as treatment liquid coating means for coating the surface of the transparent resin base material to be transported by the treatment liquid coating drum 142 with the treatment liquid. The treatment liquid coating device 144 is configured of, for example, a roller coating device and coats the surface of the transparent resin base material with the treatment liquid by pressing a coating roller having a peripheral surface to which the treatment liquid has been applied to the surface of the transparent resin base material. In addition to the function described above, for example, the treatment liquid coating device 144 can be configured of a head which performs coating by jetting the treatment liquid according to the ink jet system and a spray which performs coating by spraying the treatment liquid.

Further, the treatment liquid used for coating the surface using the treatment liquid coating unit 114 is the above-described treatment liquid and is a liquid containing an acidic compound that aggregates the components in the aqueous ink.

By coating the surface of the transparent resin base material (the ink receiving layer in the case where the ink receiving layer is provided) with the treatment liquid to record an image, the occurrence of feathering and bleeding can be prevented and high-quality images can be formed.

—Treatment Liquid Drying Treatment Unit—

The treatment liquid drying treatment unit 116 performs a drying treatment on the transparent resin base material having a surface to which the treatment liquid has been applied. This treatment liquid drying treatment unit 116 mainly includes a treatment liquid drying treatment drum 146 which transports the transparent resin base material; a paper transport guide 148; and a treatment liquid drying treatment unit 150 which dries the surface of the transparent resin base material to be transported by the treatment liquid drying treatment drum 146 by blowing hot air to the surface thereof.

The treatment liquid drying treatment unit 150 is provided in the treatment liquid drying treatment drum 146 and performs the drying treatment by blowing hot air toward the surface of the transparent resin base material to be transported by the treatment liquid drying treatment drum 146. In the present example, the configuration is made such that two treatment liquid drying treatment units 150 are provided in the treatment liquid drying treatment drum and hot air is blown toward the surface of the transparent resin base material transported by the treatment liquid drying treatment drum 146.

—Image Recording Unit—

The image recording unit 118 draws an image on the surface of the transparent resin base material by jetting aqueous inks (for example, a cyan ink (C), a magenta ink (M), a yellow ink (Y), and a black ink (K)) to the surface of the transparent resin base material. The image recording unit 118 mainly includes an image recording drum 152 which transports the transparent resin base material; a base material-pressing roller 154 which presses the transparent resin base material to be transported by the image recording drum 152 and brings the transparent resin base material into close contact with the peripheral surface of the image recording drum 152; and a head unit 156 which records an image by jetting respective colors of C, M, Y, and K ink droplets to the transparent resin base material.

The head unit 156 includes an ink jet head 200C which jets cyan (C) ink droplets according to the ink jet system; an ink jet head 200M which jets magenta (M) ink droplets according to the ink jet system; an ink jet head 200Y which jets yellow (Y) ink droplets according to the ink jet system; and an ink jet head 200K which jets black (K) ink droplets according to the ink jet system. The respective ink jet heads 200C, 200M, 200Y, and 200K are disposed at constant intervals along the transport path of the transparent resin base material transported by the image recording drum 152.

The respective ink jet heads 200C, 200M, 200Y, and 200K include a line head and are formed to have a length corresponding to the maximum base material width. The respective ink jet heads 200C, 200M, 200Y, and 200K are disposed such that a nozzle surface (surface on which nozzles are arranged) faces the peripheral surface of the image recording drum 152.

The respective ink jet heads 200C, 200M, 200Y, and 200K record an image on the transparent resin base material to be transported by the image recording drum 152 by the nozzles, formed on the nozzle surface, jetting liquid droplets of inks toward the image recording drum 152.

—Ink Drying Treatment Unit—

The ink drying treatment unit 120 performs the drying treatment on the transparent resin base material after the image recording and removes liquid components remaining on the surface of the transparent resin base material. The ink drying treatment unit 120 includes a transport unit 164 which transports the transparent resin base material on which an image has been recorded; and an ink drying treatment unit 168 which performs the drying treatment on the transparent resin base material to be transported by the transport unit 164.

The ink drying treatment unit 168 is provided in the transport unit 164 and performs the drying treatment on the transparent resin base material to be transported through a first horizontal transport path 170A. The ink drying treatment unit 168 performs the drying treatment by blowing hot air to the surface of the transparent resin base material to be transported through the first horizontal transport path 170A. A plurality of the ink drying treatment units 168 are provided along the first horizontal transport path 170A. The number of ink drying treatment units to be provided is set according to the treatment capacity of the ink drying treatment unit 168, the transport speed (printing speed) of the transparent resin base material, or the like. In other words, the number of ink drying treatment units is set such that the transparent resin base material received from the image recording unit 118 is dried while being transported through the first horizontal transport path 170A. Accordingly, the length of the first horizontal transport path 170A is also set in consideration of the capacity of the ink drying treatment unit 168.

In addition, the humidity of the ink drying treatment unit 120 is increased by performing the drying treatment. In a case where the humidity thereof is increased, since the drying treatment cannot be efficiently performed, it is preferable that the ink drying treatment unit 168 and exhaust means are provided in the ink drying treatment unit 120 and humid air generated by the drying treatment is forcibly exhausted. The exhaust means can be configured such that an exhaust duct is provided in the ink drying treatment unit 120 and the air of the ink drying treatment unit 120 is exhausted by the exhaust duct.

The transparent resin base material delivered from the image recording drum 152 of the image recording unit 118 is received by the transport unit 164. The transport unit 164 transports the transparent resin base material along with the planar guide plate 172 by allowing a gripper 164D to grip the front end of the transparent resin base material. The transparent resin base material delivered to the transport unit 164 is firstly transported to the first horizontal transport path 170A. During the transport of the transparent resin base material through the first horizontal transport path 170A, the drying treatment is performed on the transparent resin base material by the ink drying treatment unit 168 provided in the transport unit 164. In other words, the drying treatment is performed under conditions in which hot air is blown to the surface transparent resin base material and the surface temperature of the base material is in a range of 60° C. to 100° C.

The ink drying treatment unit can perform the drying treatment and an ink fixing treatment. The ink fixing treatment is performed by blowing hot air to the surface of the transparent resin base material to be transported through the first horizontal transport path similar to the drying treatment described above. The ink fixing treatment is performed under a condition in which the surface temperature of the base material is in a range of 60° C. to 100° C.

—Discharge Unit—

The discharge unit 124 discharges the transparent resin base material on which a series of image recording treatments are performed and then recovers the transparent resin base material. The discharge unit 124 mainly includes the transport unit 164 which transports the transparent resin base material and a discharge stand 176 which recovers the transparent resin base material by stacking the transparent resin base material.

### EXAMPLES

Hereinafter, the present invention will be described in more detail with reference to examples. The materials, the use amounts, the ratios, the treatment contents, and the treatment procedures shown in the examples described below can be changed as appropriate within the range not departing from the gist of the present invention. Therefore, the scope of the present invention is not limited to the specific examples shown below.

In the description below, “part” indicates “part by mass” unless otherwise noted.

### Example 1

<Transparent Resin Base Material>

(Preparation of Unstretched Laminate)

—Preparation of Resin Layer of Unstretched Laminate—

A polyethylene terephthalate (hereinafter, referred to as “PET”) resin having an intrinsic viscosity of 0.64 dL/g obtained by polycondensing a titanium compound used as a catalyst was dried until the moisture content was set to 50 ppm or less. The dried PET resin was melted in an extruder having a heater temperature which was set to be in a range of 280° C. to 300° C. The melted PET resin was extruded on a chill roll electrostatically applied from a die portion, thereby obtaining a band-like unstretched PET film 1. The obtained band-like unstretched PET film 1 was stretched at a stretch ratio of 3.3 times in the longitudinal direction (hereinafter, the “longitudinal direction is referred to as a machine direction (MD)”) and stretched at a stretch ratio of 3.3 times in the width direction, thereby obtaining a band-like uniaxially stretched PET film.

(Preparation of Unstretched Laminate)

One surface of the uniaxially stretched PET film was coated with a coating solution for forming an ink receiving layer with the following composition according to a bar coating method while the obtained uniaxially stretched PET film was transported at a transport speed of 60 m/min, and then the coating solution was dried at 145° C. for 1 minute, thereby obtaining a band-like unstretched laminate having a coating layer on one surface of the uniaxially stretched PET film.

- Composition of coating solution for forming ink receiving layer -

| | | |
|---|---|---|
| Terminal block isocyanate of polyester-based | 62.34 | parts |
| polyurethane polymer described below | | |
| (weight-average molecular weight: 6000, | | |
| solid content of 27% by mass) | | |
| Block isocyanate | 7.29 | parts |
| (weight-average molecular weight: 1000, | | |
| WM44-L70G, manufactured by Asahi Kasei | | |
| Corporation, solid content of 70% by mass) | | |
| Isocyanate reaction catalyst | 0.44 | parts |
| (organic tin aqueous dispersion liquid, | | |
| ERASTRON CAT-21, manufactured by DKS | | |
| Co., Ltd., solid content of 10% by mass) | | |
| Anionic surfactant | 0.56 | parts |
| (sodium di-2-ethylhexyl sulfosuccinate, | | |
| solid content of 1% by mass) | | |
| pH adjuster | 0.23 | parts |
| (sodium hydrogen carbonate) | | |
| pH buffer | 1.92 | parts |
| (mixture of sodium hydrogen carbonate and | | |
| sodium carbonate) | | |
| Silica | 2.01 | parts |
| (average primary particle diameter: 40 nm, | | |
| PL3D, manufactured by Fuso Chemical Co., | | |
| Ltd.) | | |
| Aggregate silica | 0.20 | parts |
| (volume average particle diameter: 4 μm to 5 μm, | | |
| AZ204, manufactured by Tosoh Corporation) | | |
| Lubricant | 1.98 | parts |
| (dispersion of carnauba wax, CELLOSOL | | |
| (registered trademark) 524, manufactured | | |
| by CHUKYO YOSHI CO., LTD., solid content | | |
| of 30% by mass) | | |

The terminal block isocyanate of a polyester-based polyurethane polymer contained in the coating solution for forming an ink receiving layer was prepared by performing the following procedures.

34 parts of hexamethylene diisocyanate was added to 200 parts of polyester containing maleic acid and an ethylene oxide adduct of bisphenol A to cause a reaction, 73 parts of a 30 mass % sodium bisulfite aqueous solution was added to the reactant, and the solution was stirred and diluted with water, thereby obtaining terminal block isocyanate of a polyester-based polyurethane polymer having a solid content of 27% by mass.

(Preparation of Stretched Laminate)

A stretched laminate including an ink receiving layer having a thickness of 0.05 μm was obtained on one surface of a biaxially stretched PET film having a thickness of 250 μm by stretching the above-described prepared band-like unstretched laminate at a stretching ratio of 4.0 times in the width direction (direction orthogonal to the stretching direction in the uniaxially stretched PET film, also referred to as a “transverse direction (TD)”) using a stretching device.

(Preparation of Lenticular Sheet 1)

—Formation of Lens Layer—

A second interlayer and a lens layer were formed on a surface of the biaxially stretched PET film on a side of the prepared stretched laminate opposite to a side where the ink receiving layer was provided, according to the following procedures.

A glycol-modified polyethylene terephthalate (PET-G) resin (manufactured by SK Chemicals Co., Ltd.) and a resin (ADMER (registered trademark), manufactured by Mitsui Chemicals Inc.) for forming a second interlayer were coextruded on the surface of the biaxially stretched PET film of the stretched laminate at an actually measured resin temperature of 260° C. to 280° C. using a T die (discharge width of 330 mm) whose temperature was set to 280° C., and the biaxially stretched PET film, the second interlayer, and the glycol-modified polyethylene terephthalate resin for forming a lens layer were laminated to have a layer structure in this order. This laminate was transported at 20 m/min and allowed to pass through a space between an embossing roller and a nip roller (ϕ350 mm, 40° C.) such that the embossing roller (ϕ350 mm, 40° C.) was brought into the contact with the surface on which the glycol-modified polyethylene terephthalate resin for forming a lens layer was laminated. The surface of the embossing roller has a lenticular lens shape (radius of 150 μm, lens pitch of 254 μm).

A lens layer was formed, through the second interlayer, on the biaxially stretched PET film of the stretched laminate which had passed through the space between the embossing roller and the nip roller. The thickness of the obtained lenticular sheet 1 was 350 μm.

As described above, a lenticular sheet 1 serving as a transparent resin base material was obtained.

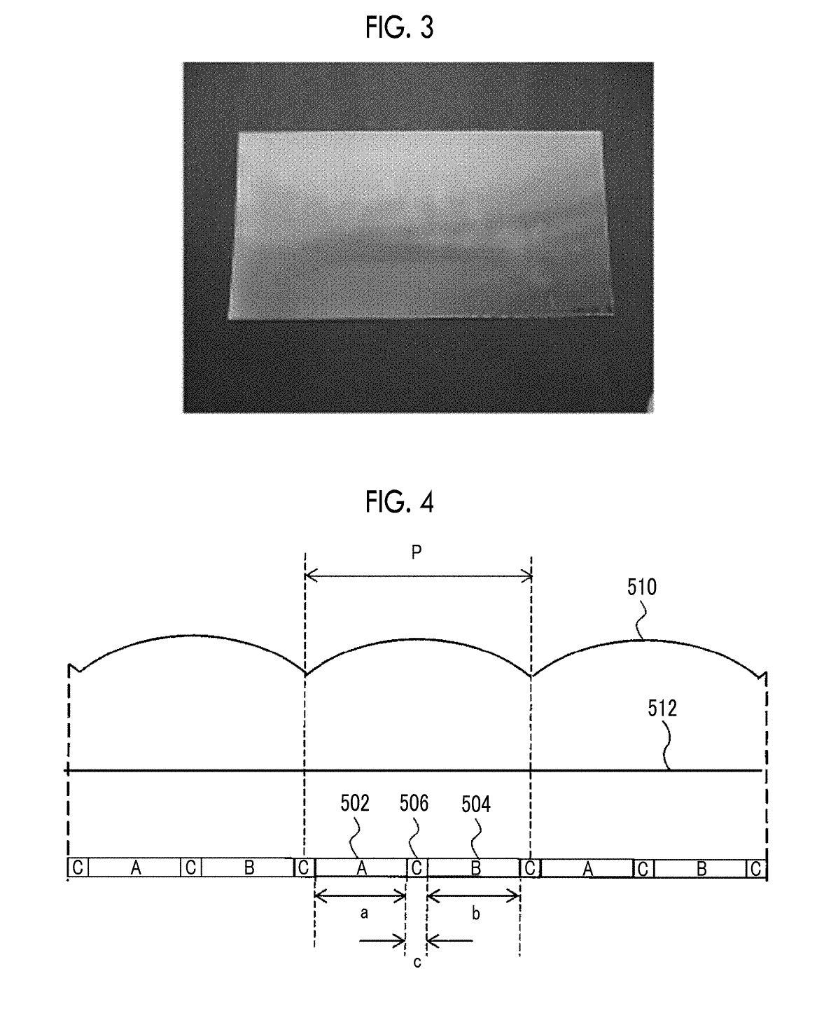

The lenticular sheet 1 produced according to the above-described production method was heated at 100° C. for 30 seconds and observed. The surface temperature of the lenticular sheet 1 at this time was increased to 100° C. FIG. 3 is a photograph of the heated lenticular sheet 1. As shown in FIG. 3, deformation was not found in the lenticular sheet 1. Accordingly, it can be said that the lenticular sheet 1 produced according to the above-described production method had excellent heat resistance.

<Aqueous Ink>

(Synthesis of Self-Dispersing Polymer Particles P-1 (Resin Particles)) 360.0 g of methyl ethyl ketone was put into a 2 L three-neck flask provided with a stirrer, a thermometer, a reflux cooling pipe, and a nitrogen gas introduction pipe and then heated to 75° C. Thereafter, a mixed solution was prepared by mixing 72.0 g of isobornyl methacrylate, 252.0 g of methyl methacrylate, 36.0 g of methacrylic acid, 72 g of methyl ethyl ketone, and 1.44 g of “V-601” (polymerization initiator, manufactured by Wako Pure Chemical Industries, Ltd., compound name: (dimethyl 2,2′-azobis(2-methylpropionate)) in another container. The mixed solution prepared in the above-described manner was added dropwise at a constant speed such that the dropwise addition was completed for 2 hours while the temperature in the flask into which methyl ethyl ketone was put was maintained to 75° C. A solution formed of 0.72 g of “V-601” and 36.0 g of methyl ethyl ketone was added thereto after the dropwise addition was completed, and a solution formed of 0.72 g of “V-601” and 36.0 g of isopropanol was added thereto after the solution was stirred at 75° C. for 2 hours, and then the solution was stirred at 75° C. for 2 hours. Thereafter, the solution was heated to 85° C. and continuously stirred for 2 hours, thereby obtaining a polymer solution of an isobornyl methacrylate/methyl methacrylate/methacrylic acid (20/70/10 [mass ratio]) copolymer.

The weight-average molecular weight (Mw) of the obtained copolymer was measured according to the following method, and the value thereof was 60000. Further, the acid value of the obtained copolymer was measured, and the value thereof was 64.9 mgKOH/g.

—Measurement of Weight-Average Molecular Weight—

The weight-average molecular weight is measured by gel permeation chromatography (GPC).

The GPC was performed using HLC-8020GPC (manufactured by Tosho Corporation), three columns of TSKgel (registered trademark), and Super Multipore HZ-H (manufactured by Tosho Corporation, 4.6 mmID×15 cm), and tetrahydrofuran (THF) as an eluent.

Further, the GPC is performed at a sample concentration of 0.45% by mass, a flow rate of 0.35 ml/min, a sample injection volume of 10 μl, and a measurement temperature of 40° C. using a differential refractive index (RI) detector.

The calibration curve was prepared using 8 samples of “F-40”, “F-20”, “F-4”, “F-1”, “A-5000”, “A-2500”, “A-1000”, and “n-propylbenzene” which are “Standard Samples TSK standard, polystyrene” (manufactured by TOSOH CORPORATION).

—Measurement of Acid Value—

The acid value is represented by the number of moles of potassium hydroxide necessary for neutralizing 1 gram (g) of resin particles, and a value acquired using a measuring method in conformity with Japanese Industrial Standard (JIS K0070:1992).

Next, 668.3 g of the obtained polymer solution was weighed, 388.3 g of isopropanol and 145.7 ml of a 1 mol/L sodium hydroxide aqueous solution were added to the solution, and the temperature in the reaction container was increased to 80° C. Thereafter, 720.1 g of distilled water was added dropwise thereto at a speed of 20 ml/min and dispersed in the solution, and the temperature in the reaction container was maintained at 80° C. for 2 hours, 85° C. for 2 hours, and then 90° C. for 2 hours under atmospheric pressure. Thereafter, the pressure inside the reaction container was reduced, and a total amount of 913.7 g of isopropanol, methyl ethyl ketone, and distilled water were distilled off, thereby obtaining an aqueous dispersion of self-dispersing polymer particles P-1 (resin particles) having a concentration of solid contents (concentration of polymer particles) of 28.0% by mass.

The glass transition temperature (Tg) of the self-dispersing polymer particles P-1 was measured according to the following method, and the temperature was 145° C.

—Measurement of Glass Transition Temperature (Tg)—

0.5 g of the aqueous dispersion of self-dispersing polymer particles in solid content was dried at 50° C. for 4 hours under reduced pressure, thereby obtaining a polymer solid content. The Tg of the obtained polymer solid content was measured using a differential scanning calorimeter (DSC) EXSTAR6220 (manufactured by Hitachi High-Tech Science Corporation). Specifically, 5 mg of the polymer solid content was sealed by an aluminum pan, the temperature of the polymer solid content was changed according to the following temperature profile in a nitrogen atmosphere, and then the Tg was acquired based on the data obtained by measurement at the time of the second temperature increase. Further, the melting point was not observed within the range of the following temperature profile.

—Temperature Profile in Measurement of Tg of Resin Particles—

30° C.→−50° C. (cooling at 50° C./min)

−50° C.→220° C. (heating at 20° C./min)

220° C.→−50° C. (cooling at 50° C./min)

−50° C.→220° C. (heating at 20° C./min)

(Preparation of Cyan Ink 1)

The solution obtained by mixing components shown in the composition of a cyan ink 1 described below was stirred at a rotation speed of 5000 rotations per minute at room temperature for 20 minutes using a mixer (L4R, manufactured by Silverson Machines, Inc.), thereby preparing a cyan ink 1.

The viscosity of the prepared cyan ink 1 was measured using VISCOMETER TV-22 (manufactured by TOKI SANGYO CO., LTD.) and the value thereof was 6 mPa·s at 30° C.

The surface tension of the prepared cyan ink 1 was measured using Automatic Surface Tensiometer CBVP-Z (manufactured by Kyowa Interface Science Co., Ltd.) and the value thereof was 38 mN/m at 25° C.

The viscosities and the surface tensions of other inks described below were measured according to the same method used for those of the cyan ink 1.

- Composition of cyan ink -

| | | |
|---|---|---|
| Cyan pigment dispersion | 18% | by mass |
| (dispersion of colorant, Project Cyan APD 3000, | | |
| manufactured by Fujifilm Imaging Colorants | | |
| Inc., pigment concentration of 14% by mass) | | |
| Propylene glycol | 8% | by mass |
| (solvent, manufactured by Wako Pure Chemical | | |
| Industries, Ltd., boiling point of 188° C.) | | |
| Ethylene glycol | 8% | by mass |
| (solvent, manufactured by Wako Pure Chemical | | |
| Industries, Ltd., boiling point of 197° C.) | | |
| Olefin (registered trademark) E1010 | 0.3% | by mass |
| (manufactured by Nissin Chemical Co., Ltd., | | |
| surfactant) | | |
| Self-dispersing polymer particles P-1 | 8% | by mass |
| (resin particles) | | |
| PVP K-15 | 0.2% | by mass |
| (manufactured by ISB CORPORATION) | | |
| Urea | 5% | by mass |
| SELOSOL 524 | 3% | by mass |
| (manufactured by CHUKYO YUSHI CO., LTD.) | | |
| Lithium chloride | 0.01% | by mass |
| (inorganic salt) | | |
| SNOWTEX (registered trademark) XS | 0.3% | by mass |
| (colloidal silica, manufactured by Nissan | | |
| Chemical Industries, Ltd.) | | |
| CAPSTONE (registered trademark) FS-63 | 0.01% | by mass |
| (surfactant, manufactured by Dupont) | | |
| BYK (registered trademark)-024 | 0.01% | by mass |
| (anti-foaming agent, manufactured by Big | | |
| Chemie Japan Co., Ltd.) | | |

| | |
|---|---|
| Ion exchange water | residual amount |
| | of 100% by |
| | mass in total |

A magenta ink 1, a yellow ink 1, and a black ink 1 were prepared in the same manner as in the preparation of the cyan ink 1 except that the cyan pigment dispersion used for preparing the cyan ink 1 was changed to a pigment dispersion listed in Table 3 and components were mixed to obtain the composition in Table 3.

The viscosity of the prepared magenta ink 1 was 6 mPa·s and the surface tension was 38 mN/m.

The viscosity of the prepared yellow ink 1 was 6 mPa·s and the surface tension was 38 mN/m.

The viscosity of the prepared black ink 1 was 6 mPa·s and the surface tension was 38 mN/m.

TABLE 3

| | | Cyan | Magenta | Yellow | Black |
|---|---|---|---|---|---|
| Composition | | ink 1 | ink 1 | ink 1 | ink 1 |
| Pigment dispersion | Projet Cyan APD 3000 | 18 | — | — | — |
| | Projet Magenta APD 3000 | — | 40 | — | — |
| | Projet Yellow APD 3000 | — | — | 25 | — |
| | Projet Black APD 3000 | — | — | — | 21 |
| Solvent | Propylene glycol | 8 | 8 | 8 | 8 |
| | Ethylene glycol | 8 | 8 | 8 | 8 |
| Surfactant | Olefin E1010 | 0.3 | 0.3 | 0.3 | 0.3 |
| Resin particles | Self-dispersing polymer | 8 | 8 | 8 | 8 |
| | particles P-1 | | | | |
| Water-soluble resin | PVP K-15 | 0.2 | 0.2 | 0.2 | 0.2 |
| Urea | Urea | 5 | 5 | 5 | 5 |
| Wax particles | CELLOSOL 524 | 3 | 3 | 3 | 3 |
| Inorganic salt | Lithium chloride | 0.01 | 0.01 | 0.01 | 0.01 |
| Colloidal silica | SNOWTEX XS | 0.3 | 0.3 | 0.3 | 0.3 |
| Surfactant | CAPSTONE FS-63 | 0 01 | 0.01 | 0 01 | 0.01 |
| Antifoaming agent | BYK-024 | 0.01 | 0.01 | 0.01 | 0.01 |
| Water | Ion exchange water | Residual | Residual | Residual | Residual |
| | | amount | amount | amount | amount |

* The unit of the numerical value of each component is % by mass, and the residual amount of water is 100% by mass in total.

The components in Table 3 will be described.
Project Magenta APD 3000: manufactured by Fujifilm Imaging Colorants Inc., pigment concentration of 14% by mass
Project Yellow APD 3000: manufactured by Fujifilm Imaging Colorants Inc., pigment concentration of 14% by mass
Project Black APD 3000: manufactured by Fujifilm Imaging Colorants Inc., pigment concentration of 14% by mass

<Treatment Liquid>

As the treatment liquid, a preconditioner C-FJ-CP (containing malic acid, malonic acid, phosphoric acid, and propanetricarboxylic acid as an acidic compound) for Jet Press (registered trademark) (manufactured by Fujifilm Corporation) was used.

The viscosity of the treatment liquid was measured using VISCOMETER TV-22 (manufactured by TOKI SANGYO CO., LTD.) and the value was 2.9 mPa·s at 25° C.

The surface tension of the treatment liquid was measured using Automatic Surface Tensiometer CBVP-Z (manufactured by Kyowa Interface Science Co., Ltd.) and the value thereof was 41.0 mN/m at 25° C.

The pH of the treatment liquid was measured using a pH meter WM-50EG (manufactured by DKK-TOA CORPORATION) and the value thereof was pH 0.78 at 25° C.

<Conditions for Forming Images>

Jet Press (registered trademark) 720 (manufactured by Fujifilm Corporation) was used as a printer. The specification and the printing conditions for Jet Press (registered trademark) 720 are described below.
Drawing system: single pass drawing
Image forming speed: 2700 sheets/hr (linear speed: 30 m/min)
Printing density: 1200 dpi×1200 dpi
Resolution: 1200 dpi×1200 dpi
Volume of ink liquid droplets

Small droplets: 2 pl, medium droplets: 7 pl, large droplets: 10 pl
Printing system

1) A treatment liquid coating unit, 2) an image recording unit, and 3) an ink drying treatment unit are respectively arranged on three impression cylinders from the upstream side in a printing system impression cylinder transport system. The order of each step is 1) a treatment liquid coating step, 2) an ink recording step, 3) a drying and fixing step from the upstream side.
Conditions for applying treatment liquid

Coating amount: 1 ml/m²
Drying conditions

Cylinder temperature: 80° C., hot air and carbon heater: 80° C., base material surface temperature: 60° C.
Fixing temperature

Cylinder temperature: 55° C., hot air: 80° C., base material surface temperature: 60° C.
Materials to be used

Treatment liquid: treatment liquid described above

Aqueous ink: yellow ink 1, magenta ink 1, cyan ink 1, and black ink 1 described above

The treatment liquid was applied onto the ink receiving layer of the lenticular sheet 1 using the above-described device, the yellow ink 1, the magenta ink 1, the cyan ink 1, and the black ink 1 were jetted thereto through a raster image processor (RIP) XMF (manufactured by Fujifilm Corporation) of Jet Press, and the ink receiving layer was dried under the above-described drying conditions. In this manner, a lenticular printed material provided with an image (parallax picture) corresponding to changing on the ink receiving layer of the lenticular sheet 1 having a size of 711 mm×508 mm was obtained.

As a result of observation of the obtained lenticular printed material, thermal deformation was not found.

In a case where the ink receiving layer was allowed to pass through RIP of Jet Press, small droplets were used on a low density side and the proportion of medium droplets was increased as the density became higher.

Further, the parallax picture means that two or more images are present under a lenticular sheet and different images are displayed depending on the viewpoint of an observer when observed through the lenticular sheet. Further, the lenticular sheet includes a lens layer on one surface side of a resin layer and an ink receiving layer on a side of the resin layer opposite to a side where the lens layer is provided.

<Formation of Parallax Picture>

As a parallax picture, two images for display with the common background and different characters to be displayed; and an image having the common image formed of only the background common to the two images for display, for the purpose of preventing the two images for display from appearing overlapping, are formed so as to match the lens pitch of the lenticular sheet.

Specifically, as illustrated in FIG. 4, an A image column 502 and a B image column 504 respectively corresponding to two images (images A and B), as images for display, with a common background and different characters; and a C image column 506 corresponding to a background image (C image column 506) common to the images A and B which was provided between the A image column 502 and the B image column 504 were disposed under each lens of a lens layer 510 through a resin layer 512. Further, the width of each image column was set by equally dividing the lens pitch P of the lens layer 510 into 24 parts, equally dividing the A image column 502 constituting the A image into 5/12 parts (width a in FIG. 4), equally dividing the B image column 504 constituting the B image into 5/12 parts (width b in FIG. 4), equally dividing the common image column 506 between the A image column 502 and the B image column 504 into 1/12 parts (width c in FIG. 4), and the common image column 506 divided into 1/12 equal parts was disposed between the A image column 502 and the B image column 504 which were adjacent to each other between lenses.

[Evaluation]

The obtained lenticular printed material was evaluated as follows. The evaluation results are listed in Table 5.

<Image Sharpness>

The image sharpness of the lenticular printed material was visually evaluated. The evaluation was based on the detail reproducibility of an image, and the sharpness was high as the details were reproduced.

1: The image sharpness is high.

2: The image sharpness is slightly inferior.

3: The image sharpness is poor.

The value of 1 or 2 is in an acceptable level

<Image Switching Properties>

The image switching properties of the lenticular printed material were visually evaluated. Specifically, the degree at which two images to be switched depending on an angle seen at the time of image changing appeared to be overlapping was visually evaluated, and the image switching properties were considered to be excellent as the angle at which two images appeared to be overlapping was smaller.

1: The switching of images was excellent over the entire surface.

2: The switching of images was slightly inferior over the entire surface.

3: The switching of images was partially poor.

4: The switching of images was poor over the entire surface.

The value of 1 or 2 is in an acceptable level.

<Image Fixing Properties>

Cellotape (registered trademark) (manufactured by NICHIBAN CO., LTD.) having a size of 10 mm×50 mm was attached to the printed surface, and the tape was peeled off from the surface for 1 second. The state of the image peeled off due to the cellotape (registered trademark) was evaluated. The value of 1 or 2 is in an acceptable level.

1: The image was not peeled off at all

2: The image was slightly peeled off, and the ratio of the area of the peeled-off image to the area of the cellotape (registered trademark) attached to the surface was 10% or less.

3: The image was partially peeled off, and the ratio of the area of the peeled-off image to the area of the cellotape (registered trademark) attached to the surface was greater than 10% and less than 100%.

4: The image in a portion where cellosolve was attached was entirely peeled off (the ratio of the area of the peeled-off image to the area of the cellotape (registered trademark) attached to the surface was 100%).

### Example 2

A transparent resin base printed material was prepared in the same manner as in Example 1 except that the biaxially stretched PET film used for preparing the lenticular sheet 1 of Example 1 was changed to an unstretched PET film 2 described below, and each of the above-described evaluations was performed. The evaluation results are listed in Table 5.

The unstretched PET film 2 was prepared by drying a glycol-modified polyethylene terephthalate (PET-G) resin until the moisture content thereof was set to 50 ppm or less, melting the dried resin in an extruder at a temperature set such that the heater temperature was in a range of 280° C. to 300° C., and extruding the resultant onto a chill roll electrostatically applied from a die portion.

### Example 3

A transparent resin base printed material was prepared in the same manner as in Example 1 except that the biaxially stretched PET film used for preparing the lenticular sheet 1 of Example 1 was changed to an unstretched PET film 3 described below, and each of the above-described evaluations was performed. The evaluation results are listed in Table 5.

The unstretched PET film 3 was prepared by drying an amorphous PET (A-PET) resin until the moisture content thereof was set to 50 ppm or less, melting the dried resin in an extruder at a temperature set such that the heater temperature was in a range of 280° C. to 300° C., and extruding the resultant onto a chill roll electrostatically applied from a die portion.

### Examples 4 and 5 and Comparative Examples 1 and 2

A transparent resin base printed material was prepared in the same manner as in Example 1 except that the types and the compositions of the propylene glycol and ethylene glycol used for preparing the cyan ink 1, the magenta ink 1, the yellow ink 1, and the black ink 1 in Example 1 were changed into the types and the compositions listed in Table 4, and each of the above-described evaluations was performed. The evaluation results are listed in Table 5.

TABLE 4

| | Boiling | Composition (% by mass) | | | | |
|---|---|---|---|---|---|---|
| | point | | | | Comparative | Comparative |
| Type of solvent | (° C. ) | Example 1 | Example 4 | Example 5 | Example 1 | Example 2 |
| Propylene glycol | 188 | 8 | | | | |
| Ethylene glycol | 197 | 8 | | | | |
| 2-pyrrolidone | 245 | | 16 | | | |
| Dipropylene glycol | 232 | | | 16 | | |
| Glycerin | 290 | | | | 16 | |
| Ethylene glycol | 124 | | | | | 16 |
| monomethyl ether | | | | | | |

### Comparative Example 3

A transparent resin base printed material was prepared in the same manner as in Example 1 except that the conditions for drying the ink drying treatment unit in the preparation of the lenticular sheet 1 of Example 1 were changed into the conditions described below, and each of the above-described evaluations was performed. The evaluation results are listed in Table 5.
Drying conditions

Cylinder temperature: 55° C., hot air and carbon heater: 70° C., surface temperature of base material: 50° C.

### Comparative Example 4

A transparent resin base printed material was prepared in the same manner as in Example 1 except that the conditions for drying the ink drying treatment unit in the preparation of the lenticular sheet 1 of Example 1 were changed into the conditions described below, and each of the above-described evaluations was performed. The evaluation results are listed in Table 5.
Drying conditions

Cylinder temperature: 80° C., hot air and carbon heater: 130° C., surface temperature of base material: 105° C.

TABLE 5

| | | Image | Image | |
|---|---|---|---|---|
| | Image | switching | fixing | |
| | sharpness | properties | properties | Remarks |
| Example 1 | 1 | 1 | 1 | |
| Example 2 | 1 | 1 | 1 | |
| Example 3 | 1 | 1 | 1 | |
| Example 4 | 1 | 1 | 2 | |
| Example 5 | 1 | 1 | 2 | |
| Comparative | 2 | 2 | 4 | |
| Example 1 | | | | |
| Comparative | 1 | 1 | 1 | Jetting omission |
| Example 2 | | | | occurred during |
| | | | | drawing |
| Comparative | 2 | 2 | 3 | |
| Example 3 | | | | |
| Comparative | 1 | 3 | 1 | |
| Example 4 | | | | |

As listed in Table 5, it was understood that the thermal deformation was suppressed and the fixing properties of the image were excellent in the case of transparent resin base printed materials of the examples.

As listed in Table 5, it was understood that the fixing properties of the image were degraded in a case where the aqueous ink did not contain a solvent having a boiling point of 150° C. to 250° C. and contains only a solvent having a boiling point of higher than 250° C. as in Comparative Example 1.

It was understood that jetting omission during drawing occurred and a desired printed material was not able to be obtained in a case where the boiling point of the solvent contained in the aqueous ink was lower than 150° C. as in Comparative Example 2.

It was understood that the fixing properties of the image were degraded in a case where the surface temperature in the drying step was lower than 60° C. as in Comparative Example 3.

It was understood that the image switching properties were degraded since the transparent resin base printed material was thermally deformed so that the parallax picture was not disposed at a desired position in a case where the surface temperature in the drying step was higher than 100° C. as in Comparative Example 4.

The disclosure of JP No. 2015-238881 filed on Dec. 7, 2015 is incorporated herein by reference.

All documents, patent applications, and technical standards described in the present specification are incorporated herein by reference to the same extent as a case of being specifically and individually noted that individual documents, patent applications, and technical standards are incorporated by reference.

What is claimed is:

1. A method of producing a transparent resin base printed material, comprising:
a treatment liquid applying step of applying a treatment liquid which contains an acidic compound onto a transparent resin base material;
an ink jetting step of jetting an aqueous ink, which contains a colorant, resin particles, water, and a solvent having a boiling point of 150° C. to 250° C. and in which a content of a solvent having a boiling point of higher than 250° C. is 1% by mass or less with respect to the total mass of the ink, onto the transparent resin base material to which the treatment liquid has been applied according to an ink jet system; and
a drying step of drying the aqueous ink under a condition in which a surface temperature of the transparent resin base material is in a range of 60° C. to 100° C.

2. The method of producing a transparent resin base printed material according to claim 1,
wherein the ink jet system is a single pass system.

3. The method of producing a transparent resin base printed material according to claim 1,
wherein the aqueous ink is jetted in the ink jetting step under jetting conditions of a resolution of 1200 dpi or greater and a minimum liquid droplet size of 3 pl or less.

4. The method of producing a transparent resin base printed material according to claim 1,
wherein the transparent resin base material is a lenticular sheet which includes a resin layer and a lens layer.

5. The method of producing a transparent resin base printed material according to claim 4,
wherein the resin layer is a biaxially stretched resin layer.

6. The method of producing a transparent resin base printed material according to claim 4,
wherein the lenticular sheet includes a lens layer on one surface of the resin layer and an ink receiving layer on the other surface of the resin layer.

7. The method of producing a transparent resin base printed material according to claim 4,
wherein a thermal shrinkage of the resin layer when heated at 150° C. for 30 minutes is in a range of 0.0%±0.6%.
